(19) United States
(12) Patent Application Publication
(10) Pub. No.: US 2021/0237511 A1
(43) Pub. Date: Aug. 5, 2021

(54) NON-PNEUMATIC WHEEL HAVING A MOLDABLE REINFORCED THERMOPLASTIC POLYURETHANE SPOKE AND A PROCESS FOR PREPARING THE SAME

(71) Applicant: Compagnie Generale des Etablissements Michelin, Clermont-Ferrand (FR)

(72) Inventors: Mark Paul KUJAWSKI, Wyandotte, MI (US); Mihai MANITIU, Wyandotte, MI (US); Raymond A. NEFF, Wyandotte, MI (US); Clayton BOHN, Jr., Mauldin, SC (US); Steven M. CRON, Simpsonville, SC (US); Damon Lee CHRISTENBURY, Greenville, SC (US); Rayn Michael GAYLO, Simpsonville, SC (US); Timothy Brett RHYNE, Greenville, SC (US)

(21) Appl. No.: 17/049,244

(22) PCT Filed: Apr. 20, 2018
(86) PCT No.: PCT/US18/28714

§ 371 Date: Oct. 20, 2020

(51) Int. Cl. B60C 7/18; B60B 9/26

(52) U.S. Cl. CPC B60C 7/18; B60C 2007/005; B60B 2900/111; B60B 9/26

(57) ABSTRACT

The present invention is directed to a moldable reinforced thermoplastic polyurethane and a non-pneumatic wheel made therefrom, a process for preparing the same and an non-pneumatic wheel obtained therefrom which exhibits a high modulus, low creep, and high fatigue life.

This invention relates generally non-pneumatic wheels and more specifically to non-pneumatic wheels comprising an outer annular band, a hub, and having a plurality of spokes extending between the hub and outer annular band where the spokes are made from, at least in part, a moldable reinforced thermoplastic polyurethane, the invention also related to a process for preparing the same.

### BACKGROUND OF THE INVENTION

The details and benefits of non-pneumatic wheels are described e.g., in U.S. Pat. Nos. 6,769,465; 6,994,134; 7,013,939; and 7,201,194. Some non-pneumatic wheel constructions incorporate a shear band, embodiments of which are described in e.g., U.S. Pat. Nos. 6,769,465 and 7,201,194. Such non-pneumatic wheels provide advantages in tire performance without relying upon a gas inflation pressure for support of the loads applied to the tire.

In one example of a non-pneumatic wheel, a compliant band with a ground contacting portion can be connected with a plurality of tension-transmitting, web-like elements (also referred to as “spokes”) extending radially from a center element or hub. By way of example, such non-pneumatic wheel may be formed by open cast molding in which a material such as e.g., polyurethane is poured into a mold that forms all or part of the non-pneumatic wheel. Alternatively the spokes may be formed individually and then attached to the outer band and hub.

Tension of the spokes is countered by circumferential compression in the outer band of the wheel. The greater the tension of the spokes, the greater the circumferential compression. Uniform spoke tension be created by a uniform pull of each of the spokes. When the wheel is placed under load, such as when it is supporting weight of a vehicle, a portion of the load is carried through circumferential compression forces in the outer band in the circumferential direction to the top of the outer band. The spokes at the top of the wheel carry a larger amount of tension which is proportional to the load applied to the wheel. This load carrying mechanism is similar to how the radial cords of a pneumatic tire carry the load of the vehicle on the top of the rim and is generally referred to as a “top loading wheels.”

Bottom loading wheels, such as solid tires, semi-solid tires, foam filled tires or spring wheels, carry a predominant portion of the load in compression against the hub of the wheel.

When a tire encounters an obstacle, such as may be encountered by a tire rolling over a surface that is not smooth or when encountering an obstacle, such as a rock, crack, pothole, or curb, the outer band is momentarily displaced and momentarily deforming the spokes beyond the amount of deformation due to deflection of the outer band in the contact patch. If the spokes have a high stiffness rate, the deformation caused by the obstacle creates a larger load transmitted to the vehicle than if the spokes have a low stiffness rate. The momentary high load created by the obstacle is perceived by the vehicle, and the operator thereof, as noise, vibration, shock, and or impulse, herein referred to as “intrusivity” with increasing intrusivity being associated with increasing noise, and or vibration, etc.

Generally, spoke stiffness increases as the spoke is extended. The slope of the stiffness of the spoke, or the tangent stiffness, compared to the displacement of the spoke, or the amount of deflection of the outer band in the contact patch, will indicate the wheels response to momentary displacements from encountering an obstacle. The greater the slope, the greater the force created as the spoke is displaced while the spoke having a smaller stiffness-displacement slope will exert less force to the vehicle when the tire encounters a momentary displacement.

Spokes constructed of a high modulus material will be stiffer than spokes having a low modulus material. Construction of spokes in traditional non-pneumatic wheels from a low modulus material creates non-pneumatic wheel spokes having the ability to absorb shock, vibration and reduce noise and impulse forces. Construction of spokes in traditional non-pneumatic wheels from high modulus materials creates non-pneumatic wheel spokes having stiffer response and a generally higher intrusively.

Using materials having a low modulus to create non-pneumatic wheels having low intrusivity require spokes having an actual length which is close to the effective length of the spoke, i.e., the distance between the spoke attachment to the hub and the spoke attachment to the outer band, such that the spokes of the tire are stretched to achieve the appropriate stiffness rate. To reduce the intrusively of the tire, the spokes may be lengthened by lengthening the effective length until the stiffness rate desired is achieved. The effective length, however, is limited by the distance between the hub and the outer band, and in effect is a limiting factor the reduction of intrusivity in the design of a non-pneumatic wheel. Complicating the design of the spokes is that while a minimum stiffness is needed in the spokes to support the weight of the vehicle, the stiffness rate of change (tangent stiffness) for the loaded tire increases quickly as the spokes are stretched to support the load. This results in spokes that, although are designed to have a low stiffness, when loaded, have a high stiffness rate (tangent stiffness), particularly when accommodating larger momentary displacements.

Such applications benefit from elastomeric materials with high moduli that can be flexed or bent tens of millions of times without failure. Such high fatigue applications benefit from the elastomeric material ability to withstand these extreme conditions yet maintaining the mechanical properties. Thermoplastic polyurethane (TPU) is one such elastomeric material which is known for its wide range of applications arising due to its mechanical and physical properties.

Generally, a thermoplastic polyurethane or a TPU refers to a multi-phase block polymer created when a polyaddition reaction occurs between an isocyanate and an isocyanate-reactive component. The isocyanate-reactive component includes a polyol. TPUs are generally known as being soft and processable when heated, hard when cooled, and capable of being reprocessed multiple times without losing structural integrity.

TPU is an excellent material, however, the modulus obtained therefrom may not be high enough for some of these high fatigue applications unless the TPU is reinforced. The addition of fillers is an important step to guarantee good mechanical and physical properties. In order to do so, thermoplastic polyurethanes (TPU) are commonly reinforced with fibers, particles, and other solids to obtain a reinforced thermoplastic polyurethane. The solids in the reinforced TPU can increase tensile strength, dimensional stability and other physical and mechanical characteristics of the non-pneumatic wheels obtained therefrom. For e.g. glass fibers may be combined with a TPU composition to produce a glass fiber-reinforced TPU with high tensile strength and improved rigidity. The glass fibers may take various forms, such as continuous or chopped strands, rovings, woven or nonwoven fabrics, and continuous or chopped strand mats.

Although, adding a reinforcement or a filler to TPU drastically increases the modulus of the non-pneumatic wheel obtained therefrom, the fatigue resistance becomes greatly reduced. Moreover, creep recovery is also compromised which results in poor mechanical performance of the non-pneumatic wheel.

Thus, it was an object of the present invention to provide a moldable reinforced TPU which when molded into an non-pneumatic wheel, improves the modulus while maintaining the fatigue life and creep recovery, thereby rendering it suitable for applications such as, but not limited to a non-pneumatic wheel.

### SUMMARY OF THE INVENTION

Surprisingly, it has been found that a moldable reinforced thermoplastic polyurethane comprising at least one thermoplastic polyurethane and at least one primary reinforcing agent having a weight ratio between the at least one thermoplastic polyurethane and the at least one primary reinforcing agent in the range of 0.01:1.0 to 1.0:1.0 when molded into an non-pneumatic wheel has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412 and can be employed for a wide range of applications such as, but not limited to non-pneumatic wheel.

Accordingly, in one aspect, the present invention is directed to a non-pneumatic wheel comprising an outer band, a hub, and a plurality of spokes, the plurality of spokes connecting the outer band to the hub, the outer band forming a contact patch when pressed against a surface, the outer band having a deflection in the contact patch the under normal loading conditions, the non-pneumatic wheel defining an axis of rotation and defining axial, radial, and circumferential directions,

wherein the plurality of spokes are made from a moldable reinforced thermoplastic polyurethane comprising:
(A) at least one thermoplastic polyurethane, and
(B) at least one primary reinforcing agent,
wherein the weight ratio between the at least one reinforcing agent (B) and the at least one thermoplastic polyurethane (A) is in the range of 0.01:1.0 to 1.0:1.0, and wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

In another aspect, the present invention is directed to a process for preparing a moldable reinforced thermoplastic polyurethane as above, comprising the steps of: (a) blending the at least one thermoplastic polyurethane (A) with the at least one primary reinforcing agent (B) in the weight ratio between the at least one reinforcing agent (B) and the at least one thermoplastic polyurethane (A) in the range of 0.01:1.0 to 1.0:1.0, optionally in the presence of the at least one additive (D) to obtain a moldable reinforced thermoplastic polyurethane having a Shore D hardness in the range of 40 to 80 determined according to ASTM D2240, wherein the moldable reinforced thermoplastic polyurethane when molded into an spoke has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

In yet another aspect, the present invention is directed to a method of molding an non-pneumatic wheel comprising the steps of:

(a′) melting a moldable reinforced thermoplastic polyurethane as above, and
(b′) molding the moldable reinforced thermoplastic polyurethane of step (a′) to obtain an non-pneumatic wheel having a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

In another aspect, the present invention is directed to a use of the moldable reinforced thermoplastic polyurethane as above or the moldable reinforced thermoplastic polyurethane obtained as above for molding into an non-pneumatic wheel.

In still another aspect, the present invention is directed to an non-pneumatic wheel comprising the moldable reinforced thermoplastic polyurethane as above or the moldable reinforced thermoplastic polyurethane obtained as above or obtained as above.

### BRIEF DESCRIPTION OF THE DRAWINGS

Other advantages of the present invention will be readily appreciated, as the same becomes better understood by reference to the following detailed description when considered in connection with the accompanying figures wherein:

FIG. 1 is a perspective representation of a geometry comprising moldable reinforced thermoplastic polyurethane according to the invention and used for determining fatigue life and creep recovery.

FIG. 2 is another perspective representation of the geometry comprising moldable reinforced thermoplastic polyurethane according to the invention and used for determining fatigue life and creep recovery, as shown in FIG. 1.

FIG. 3 provides a side view of an embodiment of the outer portion of non-pneumatic wheel having a high degree of spoke curvature.

FIG. 4 provides a partial enlarged side view of the outer portion of the non-pneumatic wheel with the spokes in a relaxed neutral state.

FIG. 5 provides a partial enlarged side view of the outer portion of the non-pneumatic wheel with the spokes in a tensioned state as they would be when connected to the hub portion of the tire.

FIG. 6 provides an enlarged partial perspective view of a single spoke, fastener assembly and a portion of the hub of an embodiment of the non-pneumatic wheel.

FIG. 7 provides an enlarged partial perspective view of a single spoke, fastener assembly and a portion of the hub of an embodiment of the non-pneumatic wheel.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, Applicant shall be entitled to any equivalents according to applicable law.

Thermoplastic polyurethanes or TPUs are an extremely diverse and versatile class of polymeric materials which find wide application in a very broad range of fields. They are generally characterized by the presence of urethane or carbamate group. The diversity of physical and mechanical properties exhibited by the TPUs arises from the ability to incorporate other chemical structures into these polymers. Such structures may be inherently rigid or flexible, or may result in crystallinity or chemical cross-linking.

Generally, the thermoplastic polyurethane is segmented. The segmented TPUs are formed from the reaction of an isocyanate and isocyanate reactive components. The isocyanate reactive component is a hydroxyl group containing compound, such as a long chain polyol. In addition to the polyol, the isocyanate reactive component may also comprise of a short chain diol as a chain extender. The TPUs are regarded as possessing alternating (AB), type block copolymeric structure, where A represents a soft segment and B represents a hard segment. Typically, the soft segment is comprised of the long chain polyol while the hard segment is derived from the isocyanate structure linked by the short chain diol. The soft segment primarily influences the elastic nature and low temperature performance, while the hard segments particularly affect the modulus, hardness and upper-use temperature by their ability to remain associated. Thus, to obtain a TPU having desired mechanical performance characteristics, the soft and hard segments need to be adjusted accordingly.

Fillers or reinforcing agents can also be added to the TPUs which result in improved performance characteristics of an article obtained therefrom.

Accordingly, a moldable reinforced thermoplastic polyurethane of the present invention comprises:

(A) at least one thermoplastic polyurethane, and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

By the term “moldable”, it is referred here that the reinforced thermoplastic polyurethane, as described hereinabove, can be molded into an non-pneumatic wheel.

For the purpose of the present invention, the moldable reinforced thermoplastic polyurethane is characterized in that the at least one thermoplastic polyurethane (A) comprises

(A1) at least one polyether polyol having a weight average molecular weight Mw in the range of 800 g/mol to 5,000 g/mol determined using size exclusion chromatography,
(A2) at least one diisocyanate, and
(A3) at least one low molecular weight diol having a molecular weight in the range of 60 to 400 g/mol.

The weight average molecular weight, as referred throughout the description and unless indicated otherwise, is determined via size exclusion chromatography procedure with the following parameters:

| | |
|---|---|
| Column | PLgel 5 μm Guard column, 100000 and 500 Å |
| | columns at 80° C. length 30 cm, diameter 7.5 mm, |
| | guard column length 5 cm diameter 7.5 mm obtained |
| | from Agilent |
| Mobile phase | Dimethylformamide (DMF) with 0.05 wt.-% LiBr |
| Flow rate | 0.8 mL/min |
| Sample injection | 100 μL of 1 mg/mL |
| Detector | Differential refractometer at 38° C. |
| Calibration | EasiCal polystyrene standards with molecular |
| | weights of M = 10,000 Da to 70,00,000 Da |

The at least one thermoplastic polyurethane (A) as described hereinabove, primarily comprises of an isocyanate component and an isocyanate reactive component. The isocyanate reactive component, as described hereinabove, is a hydroxyl group containing component or compound which reacts with the isocyanate component to form the urethane groups in the TPU. The isocyanate reactive component primarily comprises of a polyol which forms the soft segment of the TPU, as described hereinabove. In addition to the polyol, the isocyanate reactive component may also comprise a diol which acts as the chain extender in the hard segment of the TPU.

By the term “polyol”, as described hereinabove and hereinbelow, it is referred to the polymer backbones containing nominally two or more hydroxyl groups, sometimes also referred to as polyalcohols.

The polyol, as the isocyanate reactive component, is a polyether polyol having a weight average molecular weight Mw in the range of 800 g/mol to 5,000 g/mol determined using size exclusion chromatography.

Preferably, the at least one polyether polyol (A1) has a weight average molecular weight Mw in the range of 800 g/mol to 4,000 g/mol determined using size exclusion chromatography. More preferably, it is in the range of 800 g/mol to 3,000 g/mol determined using size exclusion chromatography. Most preferably, it is in the range of 800 g/mol to 2,500 g/mol, or 800 g/mol to 2,000 g/mol determined using size exclusion chromatography. In an embodiment, the at least one polyether polyol (A1) has a weight average molecular weight Mw in the range of 900 g/mol to 2,000 g/mol determined using size exclusion chromatography.

In an embodiment, the moldable reinforced thermoplastic polyurethane is characterized in that the at least one thermoplastic polyurethane (A) comprises

(A1) at least one polyether polyol having a weight average molecular weight Mw in the range of 900 g/mol to 2,000 g/mol determined using size exclusion chromatography,
(A2) at least one diisocyanate, and
(A3) at least one low molecular weight diol having a molecular weight in the range of 60 to 400 g/mol.

The at least one polyether polyol (A1) that can be employed for the present invention may be made, for example, by reacting an alkylene oxide, such as propylene oxide, with a strong base such as potassium hydroxide, optionally in the presence of water, glycols and the like. Other at least one polyether polyol (A1) which can be utilized include, but are not limited to, those which are produced by polymerization of tetrahydrofuran or epoxides such as epichlorohydrin, ethylene oxide, propylene oxide, butylene oxide, styrene oxide, for example in the presence of Lewis catalysts such as boron trifluoride or other suitable initiator compounds, or by the addition of epoxides, optionally mixed or in succession, onto starter components with reactive hydrogen atoms such as water, alcohols, ammonia, or amines. Suitable initiator compounds contain a plurality of active hydrogen atoms, and include, but are not limited to, water, butanediol, ethylene glycol, propylene glycol (PG), diethylene glycol, triethylene glycol, dipropylene glycol, ethanolamine, diethanolamine, triethanolamine, toluene diamine, diethyl toluene diamine, phenyl diamine, diphenylmethane diamine, ethylene diamine, cyclohexane diamine, cyclohexane dimethanol, resorcinol, bisphenol A, glycerol, trimethylolpropane, 1,2,6-hexanetriol, pentaerythritol, and combinations thereof.

Other suitable at least one polyether polyol (A1) include polyether diols and triols, such as polyoxypropylene diols and triols and poly(oxyethylene-oxypropylene)diols and triols obtained by the simultaneous or sequential addition of ethylene and propylene oxides to di- or tri-functional initiators. Copolymers having oxyethylene contents of from about 5 to about 90% by weight, based on the weight of the polyol component, of which the polyols may be block copolymers, random/block copolymers or random copolymers, can also be used.

In an embodiment, the at least one polyether polyol (A1) is derived from monomers selected from the group consisting of ethylene oxide, propylene oxide, butylene oxide, epichlorohydrin, styrene oxide and tetrahydrofuran. By the term “derived” as used herein, it refers to the building block of the at least one polyether polyol (A1). More preferably, it is derived from monomers selected from the group consisting of propylene oxide, butylene oxide, epichlorohydrin, styrene oxide and tetrahydrofuran. Most preferably, it is derived from monomers selected from the group consisting of butylene oxide, epichlorohydrin, styrene oxide and tetrahydrofuran. In a particularly preferable embodiment, the at least one polyether polyol (A1) is derived from the monomer of tetrahydrofuran. Tetrahydrofuran is a cyclic ether and is converted into a linear polymer called poly(tetramethylene ether) glycol (PTMEG) which is subjected to polymerization to obtain the TPU, as described hereinabove. The choice of tetrahydrofuran as the at least one polyether polyol (A1) is not limited by the method employed to obtain the same. In fact, commercially available tetrahydrofuran, such as but not limited to, PolyTHF® from BASF can be used for the purpose of the present invention. A person skilled in the art is well aware of such commercially available tetrahydrofuran.

In an embodiment, the moldable reinforced thermoplastic polyurethane is characterized in that the at least one thermoplastic polyurethane (A) comprises

(A1) at least one polyether polyol derived from the monomer of tetrahydrofuran and having a weight average molecular weight Mw in the range of 800 g/mol to 5,000 g/mol determined using size exclusion chromatography,
(A2) at least one diisocyanate, and
(A3) at least one low molecular weight diol having a molecular weight in the range of 60 to 400 g/mol.

In another preferable embodiment of the present invention, the at least one thermoplastic polyurethane (A) comprises a blend of at least two polyether polyols, as described hereinabove, having, independently of one another, a weight average molecular weight Mw in the range of 800 g/mol to 5,000 g/mol determined using size exclusion chromatography.

The amount of the at least one polyether polyol (A1) in the at least one thermoplastic polyurethane (A), as described hereinabove, is in the range of 1 wt.-% to 80 wt.-%, based on the total weight of the at least one thermoplastic polyurethane (A). Preferably, it is in the range of 1 wt.-% to 75 wt.-%, or 4 wt.-% to 75 wt.-%, or 4 wt.-% to 70 wt. %, or 7 wt.-% to 70 wt.-%, or 7 wt.-% to 65 wt.-% based on the total weight of the at least one thermoplastic polyurethane (A). More preferably, it is in the range of 10 wt.-% to 65 wt.-%, or 10 wt.-% to 60 wt.-%, or 12 wt.-% to 60 wt.-%, or 12 wt.-% to 55 wt.-%, or 14 wt. % to 55 wt.-% based on the total weight of the at least one thermoplastic polyurethane (A). Most preferably, it is in the range of 14 wt.-% to 50 wt.-%, or 17 wt.-% to 50 wt.-%, or 17 wt.-% to 45 wt.-%, based on the total weight of the at least one thermoplastic polyurethane (A). In a particularly preferable embodiment, the at least one polyether polyol (A1) is in the range of 20 wt.-% to 45 wt.-%, based on the total weight of the at least one thermoplastic polyurethane (A).

In another embodiment, the at least one polyether polyol (A1) is a combination or blend of the at least one polyether polyol (A1) and a polyether polyol (A1′) which are structurally different from each other. By the term “structurally different from each other”, it is referred to the at least one polyether polyol (A1) and the polyether polyol (A1′) having, independently of one another, a weight average molecular weight Mw in the range of 800 g/mol to 5,000 g/mol determined using size exclusion chromatography. Preferably, the polyether polyol (A1′) has a weight average molecular weight Mw in the range of 900 g/mol to 5,000 g/mol determined using size exclusion chromatography. More preferably, in the range of 900 g/mol to 4,000 g/mol determined using size exclusion chromatography. Most preferably, in the range of 900 g/mol to 3,000 g/mol determined using size exclusion chromatography.

The polyether polyol (A1′) is derived from monomers selected from the group consisting of ethylene oxide, propylene oxide, butylene oxide, epichlorohydrin, styrene oxide and tetrahydrofuran. By the term “derived” as used herein, it refers to the building block of the polyether polyol (A1 ‘). Particularly preferably, the polyether polyol (A1’) is derived from tetrahydrofuran in a manner similar to the at least one polyether polyol (A1), as described hereinabove.

In another embodiment, the moldable reinforced thermoplastic polyurethane is characterized in that the at least one thermoplastic polyurethane (A) comprises

(A1) at least one polyether polyol having a weight average molecular weight Mw in the range of 900 g/mol to 2,000 g/mol determined using size exclusion chromatography,
(A1′) a polyether polyol having a weight average molecular weight Mw in the range of 900 g/mol to 3,000 g/mol determined using size exclusion chromatography,
(A2) at least one diisocyanate, and
(A3) at least one low molecular weight diol having a molecular weight in the range of 60 to 400 g/mol.

In yet another embodiment, the at least one thermoplastic polyurethane (A), as described hereinabove, further comprises at least one polyester polyol (A4). The said at least one polyester polyol (A4) is a reaction product of at least one polyhydric alcohol (A41) with at least one polycarboxylic acid (A42). The at least one polyhydric alcohol (A41) is selected from the group consisting of 1,2-propylene glycol, 1,3-propylene glycol, glycerol, pentaerythritol, trimethylolpropane, 1,4,6-octanetriol, 1,4-butanediol, 1,5-pentanediol, 2,4-pentanediol, 1,6-hexanediol, dodecanediol, octanediol, chloropentanediol, glycerol monallyl ether, glycerol monoethyl ether, diethylene glycol, 2-ethylhexanediol-1,4, cyclohexanediol-1,4, 1,2,6-hexanetriol, 1,3,5-hexanetriol, 1,3-bis-(2-hydroxyethoxy) propane, 1,4-butylene glycol, 2,3-butylene glycol, neopentyl glycol, 1,4-bis-(hydroxymethyl)cyclohexane and trimethylolethane. While the at least one polycarboxylic acid (A42) is selected from the group consisting of phthalic acid, isophthalic acid, terephthalic acid, tetrachlorophthalic acid, maleic acid, dodecylmaleic acid, octadecenylmaleic acid, fumaric acid, aconitic acid, trimellitic acid, tricarballylic acid, 3,3′-thiodipropionic acid, succinic acid, adipic acid, malonic acid, glutaric acid, pimelic acid, sebacic acid, cyclohexane-1,2-dicarboxylic acid, 1,4-cyclohexadiene-1,2-dicarboxylic acid, 3-methyl-3,5-cyclohexadiene-1,2-dicarboxylic acid and terephthalic acid.

The at least one thermoplastic polyurethane (A) also comprises at least one diisocyanate (A2) as the isocyanate component. The at least one diisocyanate (A2) is any molecule or macromolecule which includes two isocyanate (NCO) groups. The most chemically relevant attribute of isocyanate chemistry is its reactivity with molecules having active hydrogens. Such active hydrogens are typically found on molecules having alcohol and amine functionalities and water.

The at least one diisocyanate (A2) in the present invention may have any % NCO content, any number average molecular weight and any viscosity. Preferably, the % NCO content of the at least one diisocyanate (A2) is in the range of 2 wt.-% to 50 wt.-%. Determination of the % NCO contents on percent by weight is accomplished by standard chemical titration analysis known to those skilled in the art. More preferably, the % NCO content of the at least one diisocyanate (A2) is in the range of 20 wt.-% to 50 wt.-%. Most preferably, it is in the range of 25 wt.-% to 40 wt.-%. In a particularly preferable embodiment, the % NCO content of the at least one diisocyanate (A2) is in the range of 30 wt.-% to 35 wt.-%.

For the purpose of the present invention, the at least one diisocyanate (A2) include aliphatic diisocyanate, cycloaliphatic diisocyanate, aromatic diisocyanate and mixtures thereof. Moreover, the at least one diisocyanate (A2) of the present invention is not limited to any particular genus of the diisocyanate. For instance, the at least one diisocyanate (A2) can include monomeric diisocyanate, polymeric diisocyanate and mixture thereof. By the term “polymeric”, it is referred to the polymeric grade or form of the at least one diisocyanate (A2) comprising different oligomers and homologues.

In an embodiment, the moldable reinforced thermoplastic polyurethane is characterized in that the at least one thermoplastic polyurethane (A) comprises

(A1) at least one polyether polyol having a weight average molecular weight Mw in the range of 900 g/mol to 2,000 g/mol determined using size exclusion chromatography,
(A2) at least one aliphatic diisocyanate, and
(A3) at least one low molecular weight diol having a molecular weight in the range of 60 to 400 g/mol.

In another embodiment, the moldable reinforced thermoplastic polyurethane is characterized in that the at least one thermoplastic polyurethane (A) comprises

(A1) at least one polyether polyol having a weight average molecular weight Mw in the range of 900 g/mol to 2,000 g/mol determined using size exclusion chromatography,
(A2) at least one cycloaliphatic diisocyanate, and
(A3) at least one low molecular weight diol having a molecular weight in the range of 60 to 400 g/mol.

In an embodiment, the moldable reinforced thermoplastic polyurethane is characterized in that the at least one thermoplastic polyurethane (A) comprises

(A1) at least one polyether polyol having a weight average molecular weight Mw in the range of 900 g/mol to 2,000 g/mol determined using size exclusion chromatography,
(A2) at least one aromatic diisocyanate, and
(A3) at least one low molecular weight diol having a molecular weight in the range of 60 to 400 g/mol.

Suitable cycloaliphatic diisocyanates include those in which two isocyanato groups are attached directly and/or indirectly to the cycloaliphatic ring. Aromatic diisocyanates include those in which two isocyanato groups are attached directly and/or indirectly to the aromatic ring.

The aliphatic diisocyanate and cycloaliphatic diisocyanate can comprise 6 to 100 carbon atoms linked in a straight chain or cyclized and having two isocyanate reactive end groups. The aliphatic diisocyanate is selected from the group consisting of tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate and 2-methyl-1,5-pentamethylene diisocyanate.

The cycloaliphatic diisocyanate is selected from the group consisting of cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, isocyanatomethylcyclohexane isocyanates, isocyanatoethylcyclohexane isocyanates, bis(isocyanatomethyl)cyclohexane diisocyanates, 4,4′- and 2,4′-bis(isocyanato-methyl) dicyclohexane and isophorone diisocyanate.

The aromatic polyisocyanate is selected from the group consisting 2,4- and 2,6-hexahydrotoluenediisocyanate, 1,2-, 1,3-, and 1,4-phenylene diisocyanates, naphthylene-1,5-diisocyanate, 2,4- and 2,6-toluene diisocyanate, 2,4′-, 4,4′- and 2,2-biphenyl diisocyanates, 2,2′-, 2,4′- and 4,4′-diphenylmethane diisocyanate, 1,2-, 1,3- and 1,4-xylylene diisocyanates and m-tetramethylxylyene diisocyanate (TMXDI).

Preferably, the at least one diisocyanate (A2) is selected from the group consisting of 2,4′-diphenylmethane diisocyanate, 4,4′-diphenylmethane diisocyanate, tolylene 2,6-diisocyanate, dicyclohexylmethane 2,2′-diisocyanate, dicyclohexylmethane 4,4′-diisocyanate, hexamethylene 1,6-diisocyanate, paraphenylene 2,4-diisocyanate, tetramethylenexylene 2,4-diisocyanate, 2 methylpentamethylene 1,5 diisocyanate, 2 ethylbutylene 1,4 diisocyanate, pentamethylene 1,5 diisocyanate, butylene 1,4 diisocyanate, 1 isocyanato-3,3,5 trimethyl-5 isocyanatomethylcyclohexane, 2,4′-toluene diisocyanate, 2,6′-toluene diisocyanate, and 1,5-naphthalene diisocyanate.

More preferably, the at least one diisocyanate (A2) is selected from the group consisting of 2,4′-diphenylmethane diisocyanate, 4,4′-diphenylmethane diisocyanate, tolylene 2,6-diisocyanate, dicyclohexylmethane 2,2′-diisocyanate, dicyclohexylmethane 4,4′-diisocyanate, hexamethylene 1,6-diisocyanate, paraphenylene 2,4-diisocyanate, tetramethylenexylene 2,4-diisocyanate, 2 methylpentamethylene 1,5 diisocyanate, 2 ethylbutylene 1,4 diisocyanate, pentamethylene 1,5 diisocyanate and butylene 1,4 diisocyanate.

Most preferably, the at least one diisocyanate (A2) is selected from the group consisting of 2,4′-diphenylmethane diisocyanate, 4,4′-diphenylmethane diisocyanate, tolylene 2,6-diisocyanate, dicyclohexylmethane 2,2′-diisocyanate, dicyclohexylmethane 4,4′-diisocyanate, hexamethylene 1,6-diisocyanate, paraphenylene 2,4-diisocyanate and tetramethylenexylene 2,4-diisocyanate.

In an embodiment, the at least one diisocyanate (A2) is 4,4′-diphenylmethane diisocyanate (hereinafter referred as MDI). MDI is produced from aniline and formaldehyde feedstocks. Such methods are known to a person skilled in the art. The choice of MDI is not limited to any particular method for preparing the same. Accordingly, the person skilled in the art may obtain MDI by any suitable method. In fact, MDI may be commercially obtained such as, but not limited to, Lupranat® by BASF.

Accordingly, in a preferable embodiment, the moldable reinforced thermoplastic polyurethane is characterized in that the at least one thermoplastic polyurethane (A) comprises

(A1) at least one polyether polyol having a weight average molecular weight Mw in the range of 800 g/mol to 5,000 g/mol determined using size exclusion chromatography,
(A2) 4,4′-diphenylmethane diisocyanate, and
(A3) at least one low molecular weight diol having a molecular weight in the range of 60 to 400 g/mol.

The amount of the at least one diisocyanate (A2) in the at least one thermoplastic polyurethane (A) is in the range of 1 wt.-% to 80 wt.-%, based on the total weight of the at least one thermoplastic polyurethane (A). Preferably, it is in the range of 5 wt.-% to 80 wt.-%, or 5 wt.-% to 75 wt.-%, or 10 wt.-% to 75 wt.-%, or 10 wt.-% to 70 wt.-%, or 15 wt.-% to 70 wt.-%, based on the total weight of the at least one thermoplastic polyurethane (A). More preferably, it is in the range of 15 wt.-% to 65 wt.-%, or 20 wt.-% to 65 wt.-%, or 20 wt.-% to 63 wt.-%, or 25 wt.-% to 63 wt.-%, or 25 wt.-% to 60 wt.-%, based on the total weight of the at least one thermoplastic polyurethane (A). Most preferably, it is in the range of 30 wt.-% to 60 wt.-%, or 30 wt.-% to 58 wt.-%, or 35 wt.-% to 58 wt.-%, or 40 wt.-% to 58 wt.-%, or 42 wt.-% to 58 wt.-%, based on the total weight of the at least one thermoplastic polyurethane (A). In an embodiment, the amount of the at least one diisocyanate (A2) is in the range of 45 wt.-% to 55 wt.-%, based on the total weight of the at least one thermoplastic polyurethane (A).

For the purpose of the present invention, suitable chain extenders or isocyanate reactive components include at least one low molecular weight diol (A3), amines and polyamines. By the term “low molecular weight”, it is referred to the diol having a molecular weight in the range of 60 to 400 g/mol. The chain extenders are compounds stringing together the isocyanate. As already discussed hereinabove, the chains of isocyanate and chain extender represent the hard segment of the at least one thermoplastic polyurethane (A) of the present invention. The end isocyanate units of the hard segments are implicitly connected to the at least one polyether polyols, as described hereinabove. It serves as a spacer between the neighbouring isocyanates. The chain extender structure has a significant effect on the TPU properties because of its ability to drive phase separation, to complement or interfere with a regular hard segment structure and to promote interhard segment hydrogen bonding.

Suitable amines and polyamines include aliphatic polyhydric amines such as ethylenediamine, hexamethylenediamine, and isophorone diamine; and aromatic polyhydric amines such as methylene-bis(2-chloroaniline), methylenebis(dipropylaniline), diethyl-toluenediamine, trimethylene glycol di-p-aminobenzoate; alkanolamines such as diethanolamine, triethanolamine and diisopropanolamine.

However, in a preferable embodiment, the at least one low molecular weight diol (A3) is used as the chain extender or isocyanate reactive component in the present invention. Stated another way, the at least one thermoplastic polyurethane (A) of the present invention is the reaction product of the at least one polyether polyol (A1), the at least one diisocyanate (A2) and the at least one low molecular weight diol (A3).

Preferably, the at least one low molecular weight diol (A3) has a molecular weight in the range of 60 to 350 g/mol. More preferably, in the range of 60 to 300 g/mol. Most preferably, in the range of 60 to 250 g/mol. In an embodiment, the at least one low molecular weight diol (A3) has a molecular weight in the range of 60 to 200 g/mol.

Accordingly, in a preferable embodiment, the moldable reinforced thermoplastic polyurethane is characterized in that the at least one thermoplastic polyurethane (A) comprises

(A1) at least one polyether polyol having a weight average molecular weight Mw in the range of 900 g/mol to 2,000 g/mol determined using size exclusion chromatography,
(A2) at least one diisocyanate, and
(A3) at least one low molecular weight diol having a molecular weight in the range of 60 to 200 g/mol.

The at least one low molecular weight diol (A3), as described hereinabove, is selected from the group consisting of ethylene glycol, diethylene glycol, triethylene glycol, propylene glycol, 1,3-propanediol, 1,4-butanediol, 1,5-pentanediol, 1,6-hexanediol, 1,4-butylene glycol, 1,5-pentylene glycol, methylpentanediol, 1,6-hexylene glycol, neopentyl glycol, trimethylolpropane, glycerol, pentaerythritol, diglycerol, dextrose, 1,4:3,6 dianhydrohexitol, hydroquinone bis 2-hydroxyethyl ether and bis-2(hydroxy ethyl)-terephthalate.

Preferably, the at least one low molecular weight (A3) is selected from the group consisting of ethylene glycol, diethylene glycol, triethylene glycol, propylene glycol, 1,3-propanediol, 1,4-butanediol, 1,5-pentanediol, 1,6-hexanediol, 1,4-butylene glycol, 1,5-pentylene glycol, methylpentanediol, 1,6-hexylene glycol, neopentyl glycol and trimethylolpropane. More preferably, it is selected from the group consisting of ethylene glycol, diethylene glycol, triethylene glycol, propylene glycol, 1,3-propanediol, 1,4-butanediol, 1,5-pentanediol, 1,6-hexanediol, 1,4-butylene glycol, 1,5-pentylene glycol, methylpentanediol and 1,6-hexylene glycol. Most preferably, it is selected from the group consisting of ethylene glycol, diethylene glycol, triethylene glycol, propylene glycol, 1,3-propanediol, 1,4-butanediol, 1,5-pentanediol, 1,6-hexanediol, 1,4-butylene glycol and 1,5-pentylene glycol.

In an embodiment, the at least one low molecular weight (A3) is selected from the group consisting of propylene glycol, 1,3-propanediol, 1,4-butanediol, 1,5-pentanediol and 1,6-hexanediol.

Accordingly, in a preferable embodiment, the moldable reinforced thermoplastic polyurethane is characterized in that the at least one thermoplastic polyurethane (A) comprises

(A1) at least one polyether polyol having a weight average molecular weight Mw in the range of 900 g/mol to 2,000 g/mol determined using size exclusion chromatography,
(A2) at least one diisocyanate, and
(A3) at least one low molecular weight diol selected from the group consisting of propylene glycol, 1,3-propanediol, 1,4-butanediol, 1,5-pentanediol and 1,6-hexanediol.

The amount of the at least one low molecular weight diol (A3) in the at least one thermoplastic polyurethane (A) is such that the weight ratio between the at least one low molecular weight diol (A3) and the at least one diisocyanate (A2) is in the range of 0.1:1.0 to 1.0:1.0. Preferably, the weight ratio is in the range of 0.11:1.0 to 1.0:1.0, or 0.11:1.0 to 0.95:1.0, or 0.12:1.0 to 0.95:1.0, or 0.12:1.0 to 0.9:1.0, or 0.13:1.0 to 0.9:1.0. More preferably, it is in the range of 0.13:1.0 to 0.85:1.0, or 0.14:1.0 to 0.85:1.0, or 0.14:1.0 to 0.8:1.0, or 0.15:1.0 to 0.8:1.0, or 0.15:1.0 to 0.75:1.0. Most preferably, it is in the range of 0.16:1.0 to 0.75:1.0, or 0.16:1.0 to 0.7:1.0, or 0.17:1.0 to 0.7:1.0, or 0.17:1.0 to 0.65:1.0, or 0.18:1.0 to 0.65:1.0, or 0.18:1.0 to 0.60:1.0, or 0.19:1.0 to 0.60:1.0, or 0.19:1.0 to 0.55:1.0, or 0.20:1.0 to 0.55:1.0, or 0.20:1.0 to 0.5:1.0, or 0.20:1.0 to 0.45:1.0. In an embodiment, the weight ratio between the at least one low molecular weight diol (A3) and the at least one diisocyanate (A2) is in the range of 0.2:1.0 to 0.4:1.0.

For the purpose of the present invention, the process for preparing the at least one thermoplastic polyurethane (A), as described hereinabove, does not limit the present invention moldable reinforced thermoplastic polyurethane, also described hereinabove. That is, to say, that the at least one thermoplastic polyurethane (A) may be obtained by any suitable method by reacting the components (A1), (A2), (A3) and optionally (A4) at process conditions known to the person skilled in the art. For instance, the at least one thermoplastic polyurethane (A) may be obtained by, such as but not limited to, a one-shot process or a two-shot process. By the term “one-shot” it is meant that the at least one thermoplastic polyurethane (A) formation takes place by simultaneous reaction of the at least one polyether polyol (A1), the at least one diisocyanate (A2) and the at least one low molecular weight diol (A3). Alternatively, the two-shot process or prepolymer process may also be employed, however, such processes generally require at least one step of reacting the at least one polyether polyol (A1) and the at least one diisocyanate (A2) to obtain a prepolymer followed by reacting the said prepolymer with the low molecular weight diol (A3) to obtain the at least one thermoplastic polyurethane. Moreover, the above processes may optionally take place in the presence of at least one catalyst (A5). Such a choice of the process and the at least one catalyst (A5) is well known to the person skilled in the art and therefore, the present invention is not limited by the same.

In a preferred embodiment, the moldable reinforced thermoplastic polyurethane comprises:

(A) at least one thermoplastic polyurethane comprising
(A1) at least one polyether polyol having a weight average molecular weight Mw in the range of 800 g/mol to 5,000 g/mol determined using size exclusion chromatography,
(A2) at least one diisocyanate, and
(A3) at least one low molecular weight diol having a molecular weight in the range of 60 to 400 g/mol, and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

In another embodiment, the moldable reinforced thermoplastic polyurethane comprises:

(C) at least one thermoplastic polyurethane comprising
(A1) at least one polyether polyol having a weight average molecular weight Mw in the range of 900 g/mol to 2,000 g/mol determined using size exclusion chromatography,
(A2) at least one diisocyanate, and
(A3) at least one low molecular weight diol having a molecular weight in the range of 60 to 400 g/mol, and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

In another embodiment, the moldable reinforced thermoplastic polyurethane comprises:

(D) at least one thermoplastic polyurethane comprising
(A1) at least one polyether polyol having a weight average molecular weight Mw in the range of 900 g/mol to 2,000 g/mol determined using size exclusion chromatography,
(A1′) a polyether polyol having a weight average molecular weight Mw in the range of 900 g/mol to 3,000 g/mol determined using size exclusion chromatography,
(A2) at least one diisocyanate, and
(A3) at least one low molecular weight diol having a molecular weight in the range of 60 to 400 g/mol, and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

In another embodiment, the moldable reinforced thermoplastic polyurethane comprises:

(E) at least one thermoplastic polyurethane comprising
(A1) at least one polyether polyol having a weight average molecular weight Mw in the range of 900 g/mol to 2,000 g/mol determined using size exclusion chromatography,
(A2) 2,4′-diphenylmethane diisocyanate, and
(A3) at least one low molecular weight diol having a molecular weight in the range of 60 to 400 g/mol, and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

In another embodiment, the moldable reinforced thermoplastic polyurethane comprises:

(F) at least one thermoplastic polyurethane comprising
(A1) at least one polyether polyol having a weight average molecular weight Mw in the range of 800 g/mol to 5,000 g/mol determined using size exclusion chromatography,
(A1′) a polyether polyol having a weight average molecular weight Mw in the range of 900 g/mol to 3,000 g/mol determined using size exclusion chromatography,
(A2) 2,4′-diphenylmethane diisocyanate, and
(A3) at least one low molecular weight diol having a molecular weight in the range of 60 to 400 g/mol,
and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

In still another embodiment, the moldable reinforced thermoplastic polyurethane comprises:

(G) at least one thermoplastic polyurethane comprising
(A1) at least one polyether polyol having a weight average molecular weight Mw in the range of 800 g/mol to 5,000 g/mol determined using size exclusion chromatography,
(A2) at least one diisocyanate, and
(A3) at least one low molecular weight diol having a molecular weight in the range of 60 to 200 g/mol, and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

In yet another embodiment, the moldable reinforced thermoplastic polyurethane comprises:

(H) at least one thermoplastic polyurethane comprising
(A1) at least one polyether polyol having a weight average molecular weight Mw in the range of 800 g/mol to 5,000 g/mol determined using size exclusion chromatography,
(A2) at least one diisocyanate, and
(A3) at least one low molecular weight diol selected from the group consisting of propylene glycol, 1,3-propanediol, 1,4-butanediol, 1,5-pentanediol and 1,6-hexanediol, and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

The present invention moldable reinforced thermoplastic polyurethane, as described hereinabove, also comprise at least one primary reinforcing agent (B). The at least one thermoplastic polyurethane (A), as described hereinabove, includes a primary reinforcement agent (B) to increase the modulus and improve the creep recovery.

For the purpose of the present invention, the at least one primary reinforcing agent (B) is selected from the group consisting of metal fiber, metalized inorganic fiber, metalized synthetic fiber, glass fiber, polyester fiber, polyamide fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.

Preferably, the at least one primary reinforcing agent (B) is selected from the group consisting of metal fiber, metalized inorganic fiber, metalized synthetic fiber, glass fiber, polyester fiber, polyamide fiber, graphite fiber, carbon fiber, ceramic fiber, mineral fiber, basalt fiber, inorganic fiber, aramid fiber, kenaf fiber, jute fiber and flax fiber.

More preferably, the at least one primary reinforcing agent (B) is selected from the group consisting of metal fiber, metalized inorganic fiber, metalized synthetic fiber, glass fiber, polyester fiber, polyamide fiber, graphite fiber, carbon fiber, ceramic fiber, mineral fiber, basalt fiber and inorganic fiber.

Most preferably, the at least one primary reinforcing agent (B) is selected from the group consisting of metal fiber, metalized inorganic fiber, metalized synthetic fiber, glass fiber, polyester fiber, polyamide fiber, graphite fiber, carbon fiber and ceramic fiber.

In a particularly preferable embodiment, the at least one primary reinforcing agent (B) is a glass fiber. The choice of suitable glass fibers and the process for obtaining the same is known to the person skilled in the art. For instance, the glass fiber as the primary reinforcing agent (B) is made from chopped glass fiber and/or short glass fiber. Moreover, the glass fibers may also be commercially obtained such as, but not limited to, ChopVantage® by PPG Fiber Glass.

Accordingly, in an embodiment, the moldable reinforced thermoplastic polyurethane comprises:

(I) at least one thermoplastic polyurethane, and
(J) glass fiber,
wherein the weight ratio between the glass fiber (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

In another embodiment, the moldable reinforced thermoplastic polyurethane comprises:

(K) at least one thermoplastic polyurethane, and
(L) chopped glass fiber,
wherein the weight ratio between the chopped glass fiber (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

In still another embodiment, the moldable reinforced thermoplastic polyurethane comprises:

(M) at least one thermoplastic polyurethane, and
(N) short glass fiber,
wherein the weight ratio between the short glass fiber (B) and the at least one thermoplastic polyurethane (A) is in the range of 0.01:1.0 to 1.0:1.0, and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3,000 MPa determined according to ASTM D412.

For the purpose of the present invention, the at least one primary reinforcing agent (B) may be obtained in any shape and size. For instance, the at least one primary reinforcing agent (B) may be, such as but not limited to, a strand of fiber having a lateral and through-plane dimension or a spherical particle having diameter. The present invention is not limited by the choice of the shape and size of the at least one primary reinforcing agent (B) as the person skilled in the art is well aware of the same.

The at least one primary reinforcing agent (B), as described hereinabove, has an average dimension in the range of 1 μm to 20 μm determined according to ASTM D578-98. By the term “average dimension”, it may be referred to the average size of the at least one primary reinforcing agent (B). For instance, strands of the at least one primary reinforcing agent (B) are typically characterized in terms of the fiber diameter and therefore, the average dimension would be the average fiber diameter.

In an embodiment, the at least one primary reinforcing agent (B) is subjected to a surface treatment agent. The surface treatment agent is also referred to as sizing. The at least one primary reinforcing agent (B) when subjected to a surface treatment agent further improve the mechanical properties. Typically, sizing provides adhesion between the at least one primary reinforcing agent (B) and TPU matrix. Additionally, it facilitates the processing by protecting the at least one primary reinforcing agent (B) from abrasion, integrates multiple fibers into a single strand and ensures adequate wetting by the TPU matrix.

In particular, the surface treatment agent is a coupling agent and is selected from the group consisting of a silane coupling agent, titanium coupling agent and aluminate coupling agent. Particularly preferable are the silane coupling agent and are selected from the group consisting of aminosilane, epoxysilane, methyltrimethoxysilane, methyltriethoxysilane, γ-glycidoxypropyltrimethoxysilane, vinyltriacetoxysilane and vinyltrimethoxysilane. In a preferable embodiment, the silane coupling agent is epoxysilane or aminosilane.

Accordingly, in an embodiment, the moldable reinforced thermoplastic polyurethane comprises:

(O) at least one thermoplastic polyurethane, and
(P) at least one primary reinforcing agent,
wherein the weight ratio between the at least one primary reinforcing agent (B) and the at least one thermoplastic polyurethane (A) is in the range of 0.01:1.0 to 1.0:1.0,
wherein the primary reinforcing agent (B) is subjected to the surface treatment agent and wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3,000 MPa determined according to ASTM D412.

In another embodiment, the moldable reinforced thermoplastic polyurethane comprises:

(Q) at least one thermoplastic polyurethane, and
(R) glass fiber,
wherein the weight ratio between the glass fiber (B) and the at least one thermoplastic polyurethane (A) is in the range of 0.01:1.0 to 1.0:1.0,
wherein the glass fiber (B) is subjected to the surface treatment agent and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3,000 MPa determined according to ASTM D412.

In another embodiment, the moldable reinforced thermoplastic polyurethane comprises:

(S) at least one thermoplastic polyurethane, and
(T) at least one primary reinforcing agent,
wherein the weight ratio between the at least one primary reinforcing agent (B) and the at least one thermoplastic polyurethane (A) is in the range of 0.01:1.0 to 1.0:1.0,
wherein the primary reinforcing agent (B) is subjected to a coupling agent and wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3,000 MPa determined according to ASTM D412.

In another embodiment, the moldable reinforced thermoplastic polyurethane comprises:

(U) at least one thermoplastic polyurethane, and
(V) at least one primary reinforcing agent,
wherein the weight ratio between the at least one primary reinforcing agent (B) and the at least one thermoplastic polyurethane (A) is in the range of 0.01:1.0 to 1.0:1.0,
wherein the primary reinforcing agent (B) is subjected to a silane coupling agent and
wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3,000 MPa determined according to ASTM D412.

In still another embodiment, the moldable reinforced thermoplastic polyurethane comprises:

(W) at least one thermoplastic polyurethane, and
(X) at least one primary reinforcing agent,
wherein the weight ratio between the at least one primary reinforcing agent (B) and the at least one thermoplastic polyurethane (A) is in the range of 0.01:1.0 to 1.0:1.0,
wherein the primary reinforcing agent (B) is subjected to an aminosilane coupling agent and wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3,000 MPa determined according to ASTM D412.

In another embodiment, the moldable reinforced thermoplastic polyurethane comprises:

(Y) at least one thermoplastic polyurethane, and
(Z) at least one primary reinforcing agent,
wherein the weight ratio between the at least one primary reinforcing agent (B) and the at least one thermoplastic polyurethane (A) is in the range of 0.01:1.0 to 1.0:1.0,
wherein the primary reinforcing agent (B) is subjected to an epoxysilane coupling agent and wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 40° C. and a 2% secant modulus at 20° C. in the range of 500 MPa to 3,000 MPa determined according to ASTM D412.

The amount of the at least one primary reinforcing agent (B) in the moldable reinforced thermoplastic polyurethane, as described hereinabove, is such that the weight ratio between the at least one reinforcing agent (B) and the at least one thermoplastic polyurethane (A) is in the range of 0.01:1 to 1.0:1.0. Preferably, the weight ratio is in the range of 0.01:1.0 to 0.95:1.0, or 0.015:1.0 to 0.95:1.0, or 0.015:1.0 to 0.9:1.0, or 0.02:1.0 to 0.9:1.0, or 0.02:1.0 to 0.85:1.0. More preferably, it is in the range of 0.025:1.0 to 0.85:1.0, or 0.025:1.0 to 0.8:1.0, or 0.03:1.0 to 0.8:1.0, or 0.03:1.0 to 0.75:1.0, or 0.035:1.0 to 0.75:1.0. Most preferably, it is in the range of 0.035:1.0 to 0.7:1.0, or 0.04:1.0 to 0.7:1.0, or 0.04:1.0 to 0.65:1.0, or 0.045:1.0 to 0.65:1.0, or 0.045:1.0 to 0.6:1.0, or 0.045:1.0 to 0.55:1.0, or 0.045:1.0 to 0.5:1.0, or 0.045:1.0 to 0.45:1.0, or 0.045:1.0 to 0.4:1.0, or 0.045:1.0 to 0.35:1.0, or 0.045:1.0 to 0.3:1.0, or 0.045:1.0 to 0.25:1.0. In an embodiment, the weight ratio between the at least one reinforcing agent (B) and the at least one thermoplastic polyurethane (A) is in the range of 0.045:1.0 to 0.2:1.0.

The selection and relative proportions of the at least one polyether polyol (A1), the at least one diisocyanate (A2), the at least one low molecular weight diol (A3) and the at least one primary reinforcing agent (B), as described hereinabove, impact the physical properties of the resultant moldable reinforced thermoplastic polyurethane and any non-pneumatic wheel formed therefrom in terms of tensile strength, tensile modulus, elongation at break, yield strain, hardness, tear strength, compression set, abrasion resistance, storage modulus, loss modulus, tangent delta, creep resistance, fatigue resistance and other properties such as glass transition.

Additionally, the present invention moldable reinforced thermoplastic polyurethane may also further comprise at least one additive (D). The at least one additive (D) is selected from the group consisting of wax, lubricant, ultraviolet light stabilizer, antioxidant, compatibilizer, surfactant, friction modifier, crosslinker, plasticizer, flame retardant and colorant. The choice and amount of the at least one additive (D) is well known to the person skilled in the art. Moreover, the method employed for obtaining the said at least one additive (D) does not limit the present invention and therefore any suitable methods can be used for obtaining the same.

For the purpose of the present invention, it is to be understood that the moldable reinforced thermoplastic polyurethane, as described hereinabove, when molded into an non-pneumatic wheel has the following:
(i) a fatigue life of at least 10 million cycles at sinusoidal strain of frequency 10 Hz at a displacement of ±10 mm per cycle at 23° C.,
(ii) a 2% secant modulus at 20° C. in the range of 500 MPa to 3000 MPa determined according to ASTM D412, and
(iii) a creep recovery of less than 14% at 40° C. after 48 h.

The moldable reinforced thermoplastic polyurethane also has a Shore D hardness in the range of 40 to 80 determined according to ASTM D2240. In an embodiment, the Shore D hardness is in the range of 50 to 75 determined according to ASTM D2240.

For the purpose of the present invention, the non-pneumatic wheel comprising the moldable reinforced thermoplastic polyurethane, as described hereinabove, and having a fatigue life of at least 10 million cycles at sinusoidal strain of frequency 10 Hz at a displacement of ±10 mm per cycle at 40° C., a 2% secant modulus at 20° C. in the range of 500 MPa to 3000 MPa determined according to ASTM D412, and a creep recovery of less than 14% at 40° C. after 48 h can be obtained from molding techniques such as, but not limited to, extrusion or injection molding. Such techniques are well known to the person skilled in the art and accordingly the choice of different moulds for the said techniques along with the typical process conditions can be made depending upon the desired geometry of the final non-pneumatic wheel to be obtained.

Another aspect of the present invention describes a process for preparing the moldable reinforced thermoplastic polyurethane, as described hereinabove, comprising the steps of:
2. blending the at least one thermoplastic polyurethane (A) with the at least one primary reinforcing agent (B) in the weight ratio between the at least one reinforcing agent (B) and the at least one thermoplastic polyurethane (A) in the range of 0.01:1.0 to 1.0:1.0, optionally in the presence of the at least one additive (D) to obtain a moldable reinforced thermoplastic polyurethane having a Shore D hardness in the range of 40 to 80 determined according to ASTM D2240,
   wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

The moldable reinforced thermoplastic polyurethane as obtained in the above process, has a creep recovery of less than 14% at 40° C. after 48 h.

For the purpose of the present invention, the components (A), (B), optionally (C) and/or (D) may be added in any manner and sequence in the step (a). For instance, the components may be added dropwise or all at once. The person skilled in the art is well aware of this and therefore the present invention process shall not be limited by the same. Moreover, the step (a) of the above described process can be carried out in the presence of any mixing means, such as but not limited to, a batch wise stirrer and reaction vessel, or a continuous stirrer and reaction vessel, or a reaction extruder. The choice of such mixing means is also known to the person skilled in the art.

Yet another aspect of the present invention describes a method of molding the non-pneumatic wheel comprising the steps of:

(a′) melting the moldable reinforced thermoplastic polyurethane, as described hereinabove, and
(b′) molding the moldable reinforced thermoplastic polyurethane of step (a′) to obtain the non-pneumatic wheel having a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

Molding the non-pneumatic wheel in the manner as described hereinabove, results in the non-pneumatic wheel having a creep recovery of less than 14% at 40° C. after 48 h.

In step (a′) of the method described hereinabove, the moldable reinforced thermoplastic polyurethane is subjected to melting. The temperature for melting the moldable reinforced thermoplastic polyurethane depends on the amount of the components (A), (B), optionally (C) and/or (D). In an embodiment, the melting temperature maintained in step (a′) is in the range of 170° C. to 220° C.

The moldable reinforced thermoplastic polyurethane obtained in step (a′) is molded to obtain the non-pneumatic wheel in step (b′). For the purpose of molding in step (b′), any suitable mould or geometry may be selected.

In an embodiment, molding techniques such as, but not limited to, injection molding or extrusion may be employed in step (b′). Such techniques are well known to the person skilled in the art and accordingly the choice of different moulds for the said techniques along with the typical process conditions can be made depending upon the desired geometry of the final non-pneumatic wheel to be obtained.

For the purpose of the present invention, the non-pneumatic wheel comprising the moldable reinforced thermoplastic polyurethane, as described hereinabove or hereinbelow, is employed for measuring the fatigue life and creep recovery. Other mechanical properties, such as but not limited to, secant modulus and shore hardness may be measured using the standard techniques available with the person skilled in the art. As discussed hereinabove, the non-pneumatic wheel may be obtained from molding techniques such as but not limited to, injection molding or extrusion and can have any shape and/or size.

In an embodiment, the 2% secant modulus can be determined from test samples which have been annealed at 80° C. for 20 hours after molding, then rested at room temperature for at least 24 hours. Tensile testing and dynamic mechanical analysis (DMA) can be conducted on ASTM D412 Die “C” specimen stamped from 2 mm thick injection molded test plaques. DMA technique is used to measure the glass transition temperature (Tg) using a film and fiber sample fixture. The test frequency is 10 Hz and the temperature ramp rate is 2° C./min. In order to measure the Tg value, storage modulus (E′) and loss modulus (E″) are first determined. The storage modulus (E′) represents the stiffness of the polymer material and is proportional to the energy stored during a loading cycle. The loss modulus (E″) is defined as being proportional to the energy dissipated during one loading cycle. It represents, for example, energy lost as heat, and is a measure of vibrational energy that has been converted during vibration and that cannot be recovered. Tg obtained using the E″ values are typically lower than −30° C. for the present invention.

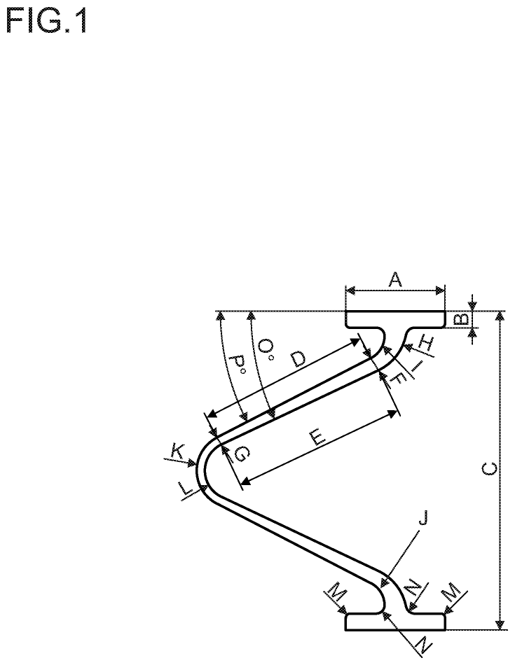

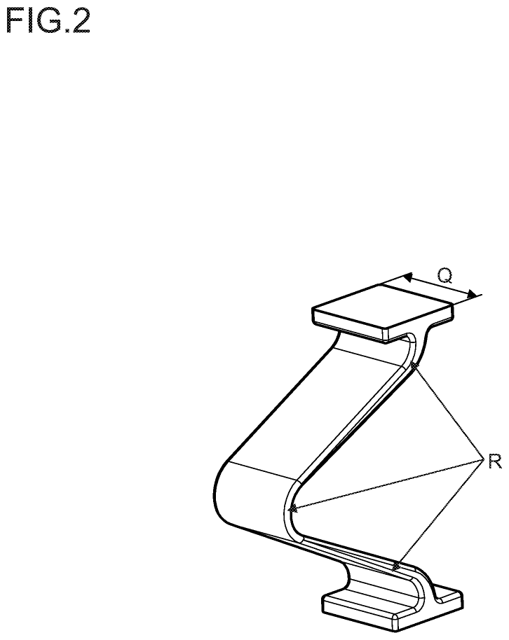

Calculation of the 2% secant modulus was done by dividing the stress measured at 2% strain by 0.02. However, the fatigue life and creep recovery were tested on a different geometry, such as but not limited to the one described in FIG. 1 and FIG. 2.

In a particularly preferable embodiment, the non-pneumatic wheel for determining the fatigue life and creep recovery has a geometry as depicted in FIG. 1 and FIG. 2. For the purpose of the present invention, the geometry may be interchangeably referred as test specimen. The geometry or test specimen is a “V” shaped I-beam with rounded edges. Various reference numerals along with the dimension of the mold for obtaining the geometry are described hereinbelow as:

| Reference numeral | Description | Dimension |
|---|---|---|
| A | First flat horizontal surface | 0.025 m |
| B | First flat vertical surface | 0.004 m |
| C | Total vertical height of the geometry | 0.076 m |
| D | First flat inclined surface | 0.042 m |
| E | Second flat inclined surface | 0.042 m |
| F | First thickness | 0.004 m |
| G | Second thickness | 0.002 m |
| H | First rounded surface | 0.012 m |
| I | Second rounded surface | 0.002 m |
| J | Third rounded surface | 0.006 m |
| K | Fourth rounded surface | 0.009 m |
| L | Fifth rounded surface | 0.007 m |
| M | First rounded edge | 0.001 m |
| N | Second rounded edge | 0.002 m |
| O | Outer angle | 25.305° |
| P | Inner angle | 27.305° |
| Q | Second flat horizontal surface | 0.025 m |
| R | Third rounded edge | 0.001 m |

As referred hereinabove, the terms “flat”, “vertical”, “horizontal”, “inclined” and “rounded” have the typical meanings known to the person skilled in the art. Further, the angles “O” and “P” are subtended with the horizontal and may have any values known to the person skilled in the art, subject to the geometry being “V” shaped. Moreover, the mold dimensions, as described hereinabove, have a tolerance typically of ±0.005 inches and the geometry obtained using the said mold may contract not more than 3%.

Fatigue life or fatigue testing is defined as the process of progressive localized permanent structural change occurring in a material subjected to conditions that produce fluctuating stresses and strains at some point or points and that may culminate in cracks or complete fracture after a sufficient number of fluctuations. Fatigue life relates to how long an object or material will last before completely failing because of concentrated stresses. It depends on a number of factors, such as but not limited to, the type of material, its structure, its shape and temperature changes. For the purpose of the present invention, the fatigue life can be measured using any suitable instrument. Such an instrument is well known to the person skilled in the art. Nevertheless, a dynamic servo hydraulic tensile testing station may be employed. As described hereinabove, the fatigue life testing is conducted at sinusoidal strain of frequency 10 Hz at a displacement of ±10 mm per cycle at 23° C. and is typically at least 10 million cycles. By the term “displacement of ±10 mm per cycle”, it is referred to one strain cycle displacing the geometry ±10 mm from its neutral position i.e. when the geometry is clamped in the instrument at its neutral position, grips open by +10 mm, return to neutral, contract to −10 mm and again return to neutral. Excellent fatigue life is considered as achieving 10 million strain cycles without breaking, cracking or showing significant hazing or whitening.

Creep recovery is another parameter that is determined using the above described geometry or non-pneumatic wheel. A simple way to express creep is to measure the ability of a material to re-gain its calliper, after being submitted to extensional forces, such as a load or displacement applied to the material, for an extended period of time. In order to determine the creep recovery, a pair of test specimen or a pair of the geometries described hereinabove, were clamped at the top and bottom in series to one another. The pair of test specimens were clamped back-to-back to neutralize any torque generated by the offset load and ensure that the displacement was only along the vertical axis. A constant force was applied to the bottom clamp and the top clamp was fixed in place. Creep testing was conducted at 40° C. using an environmental testing chamber. The force to be applied to the pair test specimen for creep testing was determined ahead of time by using a tensile testing station with an environmental test chamber set to 40° C. to measure the force required to extend the test specimen by +10 mm at 40° C. This constant force was applied to the test specimens for 48 hours at 40° C., causing the test specimens to elongate. The constant force was then removed and the test specimens were then placed at 23° C. for another 24 hours, after which the elongation of the test specimens were recorded. The nonrecoverable deformation, or creep, was defined as the ratio of the initial geometry to the final geometry and was reported as a percentage. Excellent creep resistance was considered as less than 14% nonrecoverable deformation under the prescribed conditions.

Still another aspect of the present invention describes use of the moldable reinforced thermoplastic polyurethane as described hereinabove or the moldable reinforced thermoplastic polyurethane obtained according to the process as described hereinabove, for molding into the non-pneumatic wheel. By the term “molding” as described hereinabove and hereinbelow, it is referred to injection molding or extrusion techniques.

In an embodiment, the moldable reinforced thermoplastic polyurethane is used in applications which require elastomeric materials with high modulus that can be flexed or bent tens of millions of times without failure. Such applications can be, such as but not limited to, a non-pneumatic wheel.

A further aspect of the present invention describes the non-pneumatic wheel comprising the moldable reinforced thermoplastic polyurethane as described hereinabove or the moldable reinforced thermoplastic polyurethane obtained according to the process described hereinabove or obtained according to the molding method described hereinabove or as used hereinabove. For the purpose of the present invention, the non-pneumatic wheel can be, such as but not limited to non-pneumatic wheel.

Still another aspect of the present invention describes a process for preparing a non-pneumatic wheel, comprising the steps of: (NP1) injection molding the moldable reinforced thermoplastic polyurethane as described hereinabove or the moldable reinforced thermoplastic polyurethane obtained according to the process described hereinabove to obtain a non-pneumatic wheel, wherein the non-pneumatic wheel has a fatigue life of at least 10 million cycles at sinusoidal strain of frequency 10 Hz at a displacement of ±10 mm per cycle at 23° C., a 2% secant modulus at 20° C. in the range of 500 MPa to 3000 MPa determined according to ASTM D412 and a creep recovery of less than 14% at 40° C. after 48 h.

Particular embodiments of the present invention include non-pneumatic wheels having a plurality of spokes that extend between its hub and its outer ring. The outer ring supports an outer band having the tread, which is, as is known, the surface that engages the ground. In some embodiments, each of the plurality of spokes is placed in the non-pneumatic wheel in a state of pretention or pre compression. It has been found that such a non-pneumatic wheel, having spokes formed of a suitable material, improves the intrusivity characteristics of the non-pneumatic wheel. The non-pneumatic wheels disclosed herein are useful for a wide range of applications including, for example, slow moving vehicles such as golf carts, lawn mowers, front-end loaders and other similar slow-moving heavy vehicles. However particular embodiments are directed to fast moving vehicles such as automobiles and/or other vehicles that generally are found on highways since the non-pneumatic wheels disclosed herein provide improved intrusivity characteristics as are desired for fast moving vehicles such as automobiles.

As will be further explained below, particular embodiments of the non-pneumatic wheels disclosed herein have an amount of pretention or precompression in the spokes that is at least equal to or greater than the amount of deflection that the non-pneumatic wheel undergoes when placed under its designated Design Load. Such designated Design Load is determined by the manufacturer and is typically indicated on the sidewall of the non-pneumatic wheel. It is, as those skilled in the art understand, the maximum load at which the non-pneumatic wheel is expected and/or is designed to operate.

The material from which the plurality of spokes is manufactured is a high rigidity material. In addition to the non-pneumatic wheels disclosed herein having spokes that are set in pretention, it has been found that intrusivity characteristics of the non-pneumatic wheels disclosed herein are improved when such spokes are made of high rigidity materials. In particular embodiments, though not meant to limit the invention only to this material, some nylons or polyamides have been found to be suitable materials for forming the spokes.

More particularly and as is further discussed below, a suitable polyamide is one having a conditioned tensile modulus of between 600 MPa and 3000 MPa as determined by ISO-527-2, an equilibrium moisture content of no more than 1.5% as determined at 23° C. and 50% relative humidity by ISO 62 and a fatigue failure resistance that can withstand at least 1 million cycles as determined by ASTM D7774, a three-point bend test at 23° C. with 2% strain at 10 Hz. Such polyamides provide spokes that have suitable physical characteristics that include, for example, fatigue resistance and/or creep resistance. Examples of suitable polyamides include selections from PA12, PA11 and PA612 polyamides.

“Axial direction” or the letter “A” in the figures refers to a direction parallel to the axis of rotation of for example, the shear band, tire, and/or wheel as it travels along a road surface.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the shear band and/or wheel structure.

“Radial plane” means a plane that passes perpendicular to the equatorial plane and through the axis of rotation of the wheel.

Design Load” means the maximum load at which the non-pneumatic wheel is expected and/or is designed by the manufacturer to operate and is typically displayed on the sidewall of the wheel.

“Delta stiffness” means the slope of the line drawn on a plot of force over displacement, with the slope measured from a position where the object is unstressed and exerting no force, to the position where the object is exerting the force from which the stiffness is calculated by dividing the force by the displacement.

“Tangent stiffness” means the slope of the line drawn on a plot of force over displacement where the slope is measured by the change in force divided by the change in displacement. In other words, the tangent slope is the slope of a line that is drawn tangent to line drawn of a plot of force over displacement for the object at a given location on the force over displacement line.

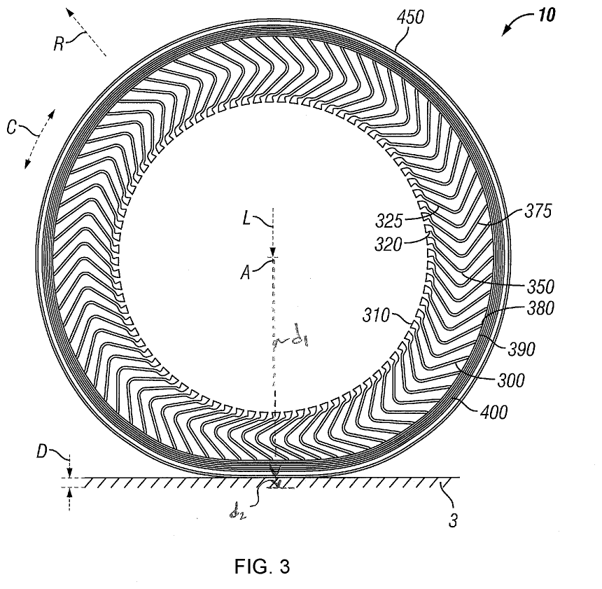

FIG. 3 provides a side view of an embodiment of the outer portion of non-pneumatic wheel having a high degree of spoke curvature. The wheel 10 shown here is resting on a surface 3. A load L is applied to the hub of the wheel, which could represent the weight, or a portion thereof, of the vehicle. When the load L is applied, the wheel is pressed against the surface 3 and the outer band deflects a distance D. Expressed another way, the outer band deflection D is the difference between a first radial length d2 between the axis centerpoint of the wheel and a radially outermost point on the outer band in an unloaded state and a second radial length d1 between the axis centerpoint and the radially outermost point on the outer band in the center of the contact patch. When the load L is equal to the Design Load, then the outer band deflection is the outer band deflection at design load DDL. The area of contact is referred to as the “contact patch” and, as is known by those skilled in the art, provides an area over which the wheel interfaces and reacts with the surface on which it travels.

When viewed from the axial side of the wheel, in particular embodiments the spoke 300 possess a V-shaped geometry. This geometry allows for a nearly linear stiffness when deflected radially over a distance approximately equal to the deflection DDL. This characteristic results in improved intrusivity properties since comparatively lower force transmission occurs through the wheel during a dynamic loading event, such as when the wheel 10 encounters an obstacle such as a crack, rock or curb in the road, than with non-pneumatic wheels having spokes possessing less curvature, i.e., a spoke having an actual length closer to the effective length.

In particular embodiments, the V-shaped geometry of the spoke begins at the attachment point 380 of the spoke to the outer band 400. A radially outer portion 375 of the spoke 300 extends radially inward and circumferentially in a clockwise direction. The spoke then curves forming a radiused nose 350. The radially inner portion 325 continues in a radially inward and circumferentially in a counter-clockwise direction to hub attachment point 320 which may possess a dovetail thickened portion 310 for engagement with a fastener.

The spoke's V-shaped geometry allows the spoke 300 to nest with each adjacent spoke 300 on either side of it, preventing the spokes from clashing into each other during normal operating conditions, such as rolling under the intended design loading conditions for the wheel. The nesting enables the nose of the spoke to extend circumferentially past a straight line drawn between the connection point of an adjacent spoke with the hub and the connection point of the adjacent spoke with the outer band.

It should be understood that normal loading conditions of the wheel are defined as the load for which the wheel is designed to carry under normal operating conditions, such as when the vehicle to which the wheel is attached is loaded at capacity and rolling along a flat road surface. Normal loading conditions may be defined as the design load capacity of the wheel. For wheels that lack a defined normal loading condition, the normal loading condition shall be considered the maximum load capacity of the tire.

In the embodiment shown here, the spokes 300 are integrally formed with an outer ring 390 which is attached to the outer band 400. Alternatively the spokes may be formed individually and bonded individually with the outer band 400.

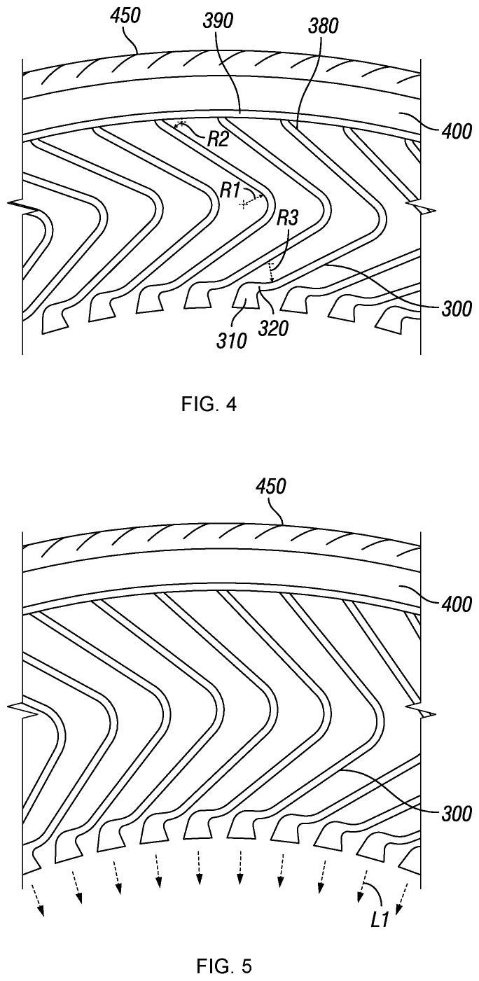

FIG. 4 provides a partial enlarged side view of the outer portion of the non-pneumatic wheel 10 with the spokes 300 in a relaxed neutral state. The outer band 400 of the wheel possesses a tread 450. The relaxed neutral state is the position that the spokes would assume when they are disconnected from the hub, or in other words, when the spokes have no pretention applied to the spokes. The spokes may possess a dovetail portion 310 at the radially inner portion of the spoke. The radially inner portion of the spoke extends out in a circumferential direction from the dovetail 310 at the connection point 320 with the dovetail. The spoke extends to a nose portion 350 which in this embodiment possesses a radius R1. The radius R1 reduces bending stresses as compared to a sharp v-shaped nose. The spoke then extends from the nose portion 350 to the radially outer connection point 380 which then, after another radiused bend R2 of this embodiment, joins to the outer ring 390 which is attached with the outer band 400.

FIG. 5 provides a partial enlarged side view of the outer portion of the non-pneumatic wheel 10 with the spokes 300 in a tensioned state as they would be when connected to the hub portion of the wheel. Here a force L1 is applied to the radially inner end of the spokes 300 extending the spokes radially inward toward the central axis of the wheel 10. When the spoke 300 is attached to the hub 100, the radial displacement of the spoke creates the pretension L1. In particular embodiments of the non-pneumatic wheels disclosed herein, the radial displacement due to pretension should be greater than the amount of deflection D the wheel undergoes during normal operation in the contact patch. It is anticipated, however, that a dynamic loading event may cause the spoke to momentarily compress past its neutral state. Likewise, embodiments having precompressed spokes would have a radial displacement due to the precompression greater than to amount of deflection D of the wheel undergoes during normal operation on the side opposite of the contact patch where greatest tension is experienced by the spoke.

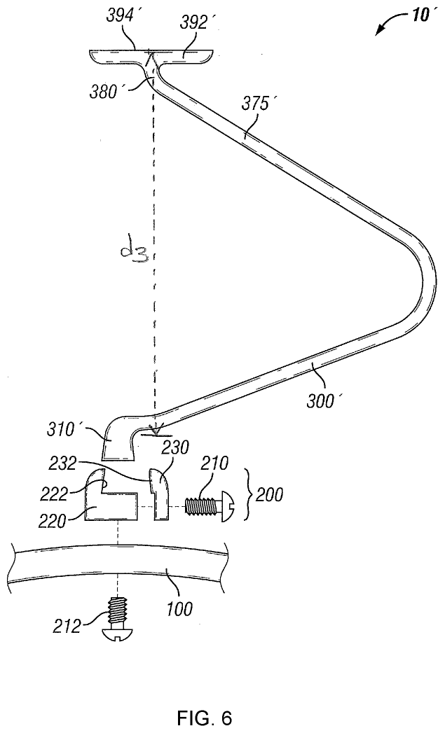

FIG. 6 provides an enlarged partial perspective view of an alternative embodiment of a single spoke 300′, fastener assembly 200 and a portion of the hub 100 of an embodiment of a non-pneumatic wheel 10′. Here the hub 100 is shown attached to the spoke 300′ by a fastener assembly 200. The fastener assembly creates a slot which clamps on to the dovetail portion 310′ of the spoke. The fastener assembly 200 includes an L-shaped bracket 220, a bracket plate 230 and at least one faster 210. Here a plurality of screw fasteners 210 retain the bracket plate 230 onto the L-shaped bracket 220 which impinge the dovetail portion 310′ of the spoke 300′ by clamping it with the inner surfaces 222, 232 of the bracket.

The radially outer portion 375′ of the spoke 300′ possesses a T-shaped radially outer end 392′ which provides a surface 394′ that is attached to the outer band 400. In the embodiment shown, the radially outer surface 394′ of the spoke 300′ is bonded with an adhesive chosen depending upon the materials used for the outer band and spoke 300′.

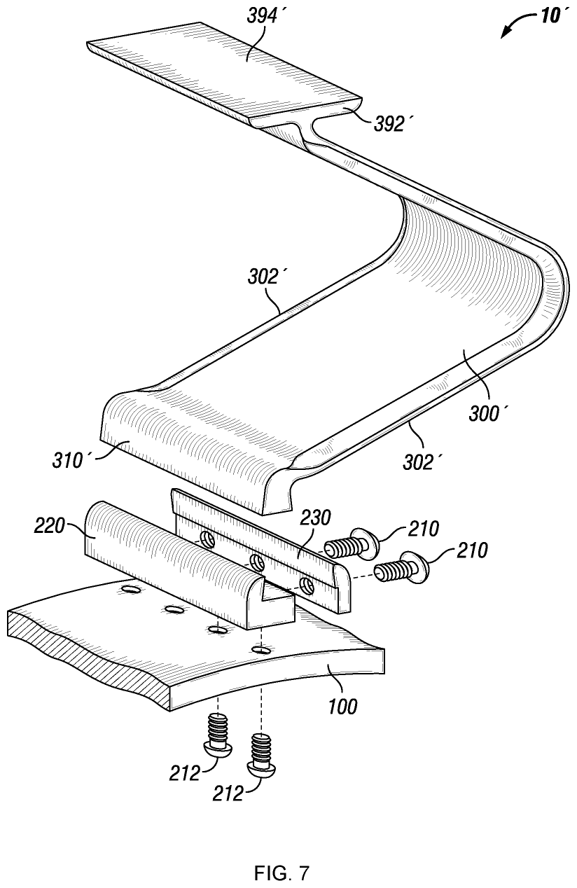

FIG. 7 provides an enlarged partial perspective view of the single spoke 300′, fastener assembly 200 and a portion of the hub 100 of the embodiment of the non-pneumatic wheel 10′. A plurality of fasteners 212 retains the L-shaped bracket 220 to the hub 100. Likewise, a plurality of fasteners 210 retains the bracket plate 230 to the L-shaped bracket 220 and provide impinging force to retain the thickened radially inner end 310′ of the spoke 300′. Alternative embodiments, not shown, may possess thickened shapes other than a dovetail or triangular shape as shown for the thickened radially inner end 310′, such as a circular shape or rectangular shape. Alternative embodiments may also retain the spoke by sliding the thickened radially inner end 310′ of the spoke into a corresponding slot in the hub, the slot being appropriately sized to accommodate and retain the thickened radially inner end of the spoke 300′.

The low spring rate of the spoke allow for a tangent stiffness that is lower than the tangent stiffness of a similarly sized non-pneumatic wheel constructed with spokes that possess less curvature. Here, the circumferentially elongated spoke curvature allows the outer band to displace vertically over a greater distance without generating as great of a reaction force in the spokes at the top of the wheel than would occur if the spokes were shorter. In the embodiments shown, the spokes have a circumferential length, as measured from the circumferential distance from a line drawn between the connection to the hub and connection to the outer band to the front of the nose of the spoke which is at least 75 percent of that of the distance of the uncompressed (neutral) height of the spoke, the uncompressed height d3 being measured between the connection point to the hub and the connection to the outer band of the spoke in a neutral, unloaded, state. In the embodiment shown in FIGS. 6 and 7, the circumferential length is at least 80% of that of the uncompressed height of the spoke. When pulled into tension, the circumferential length of the spoke is at least 25% that of the tensioned height, when pretension is applied. That is to say, the circumferential length of the spoke decreases from at least 75% of the uncompressed height of the spoke in a neutral, unloaded state to at least 25% of the tensioned height of the spoke in the tensioned state.

Surprisingly increasing the modulus of a spoke material allows the creation of a spoke having a lower, and nearly linear, tangent stiffness. This is accomplished in part by applying a pretention to the spokes such that the displacement of the spokes from a neutral position is equal to or greater than the displacement of the wheel's contact patch. The pretension also maintains the top loading nature of the wheel, allowing the wheel to carry the load by the spokes in tension unlike previously attempts at bottom loading spring wheels Other embodiments utilize precompressed spokes and compared to embodiments where the spokes are in pretension, such embodiments utilizing spoke precompression support more of the load with the spokes on the bottom of the tire and in the contact patch. It is possible in yet other embodiments for the spokes to have a more neutral compressive state when installed between the hub and outer band, neither being in a state of compression or tension until the wheel is loaded against a surface.

The present invention is illustrated in more detail by the following embodiments and combinations of embodiments which result from the corresponding dependency references and links:
1. A moldable reinforced thermoplastic polyurethane comprising:
   (AA) at least one thermoplastic polyurethane, and
   (BB) at least one primary reinforcing agent,
   wherein the weight ratio between the at least one reinforcing agent (B) and the at least one thermoplastic polyurethane (A) is in the range of 0.01:1.0 to 1.0:1.0, and
   wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.
2. The thermoplastic polyurethane according to embodiment 1, characterized in that the at least one thermoplastic polyurethane (A) comprises
   (A1) at least one polyether polyol having a weight average molecular weight Mw in the range of 800 g/mol to 5,000 g/mol determined using size exclusion chromatography,
   (A2) at least one diisocyanate, and
   (A3) at least one low molecular weight diol having a molecular weight in the range of 60 to 400 g/mol.
3. The thermoplastic polyurethane according to embodiment 2, characterized in that the at least one polyether polyol (A1) has a weight average molecular weight Mw in the range of 800 g/mol to 2,000 g/mol determined using size exclusion chromatography.
4. The thermoplastic polyurethane according to embodiment 2 or 3, characterized in that the at least one polyether polyol (A1) is derived from monomers selected from the group consisting of ethylene oxide, propylene oxide, butylene oxide, epichlorohydrin, styrene oxide and tetrahydrofuran.
5. The thermoplastic polyurethane according to one or more of embodiments 2 to 4, characterized in that the polyether polyol (A1) is derived from tetrahydrofuran.
6. The thermoplastic polyurethane according to one or more of embodiments 2 to 5, characterized in that the amount of the at least one polyether polyol (A1) is in the range of 1 wt.-% to 80 wt.-%, based on the total weight of the at least one thermoplastic polyurethane (A).
7. The thermoplastic polyurethane according to one or more of embodiments 2 to 6, characterized in that the at least one diisocyanate (A2) is selected from the group consisting of 2,4′-diphenylmethane diisocyanate, 4,4′-diphenylmethane diisocyanate, tolylene 2,6-diisocyanate, dicyclohexylmethane 2,2′-diisocyanate, dicyclohexylmethane 4,4′-diisocyanate, hexamethylene 1,6-diisocyanate, paraphenylene 2,4-diisocyanate, tetramethylenexylene 2,4-diisocyanate, 2 methylpentamethylene 1,5 diisocyanate, 2 ethylbutylene 1,4 diisocyanate, pentamethylene 1,5 diisocyanate, butylene 1,4 diisocyanate, 1 isocyanato-3,3,5 trimethyl-5 isocyanatomethylcyclohexane, 2,4′-toluene diisocyanate, 2,6′-toluene diisocyanate, and 1,5-naphthalene diisocyanate.
8. The thermoplastic polyurethane according to embodiment 7, characterized in that the at least one diisocyanate (A2) is 2,4′-diphenylmethane diisocyanate.
9. The thermoplastic polyurethane according to one or more of embodiments 2 to 8, characterized in that the amount of the at least one diisocyanate (A2) is in the range of 1 wt.-% to 80 wt.-%, based on the total weight of the at least one thermoplastic polyurethane (A).
10. The thermoplastic polyurethane according to one or more embodiments 2 to 9, characterized in that the at least one low molecular weight diol (A3) has a molecular weight in the range of 60 g/mol to 200 g/mol.
11. The thermoplastic polyurethane according to one or more of embodiments 2 to 10, characterized in that the at least one low molecular weight diol (A3) is selected from the group consisting of ethylene glycol, diethylene glycol, triethylene glycol, propylene glycol, 1,3-propanediol, 1,4-butanediol, 1,5-pentanediol, 1,6-hexanediol, 1,4-butylene glycol, 1,5-pentylene glycol, methylpentanediol, 1,6-hexylene glycol, neopentyl glycol, trimethylolpropane, glycerol, pentaerythritol, diglycerol, dextrose, 1,4:3,6 dianhydrohexitol, hydroquinone bis 2-hydroxyethyl ether and bis-2(hydroxy ethyl)-terephthalate.
12. The thermoplastic polyurethane according to one or more of embodiments 2 to 11, characterized in that the weight ratio between the at least one low molecular weight diol (A3) and the at least one diisocyanate (A2) is in the range of 0.1:1.0 to 1:1.0.
13. The thermoplastic polyurethane according to one or more of embodiments 1 to 12, characterized in that the at least one thermoplastic polyurethane (A) further comprises at least one polyester polyol (A4).
14. The thermoplastic polyurethane according to embodiment 13, characterized in that the polyester polyol (A4) is a reaction product of at least one polyhydric alcohol (A41) with at least one polycarboxylic acid (A42).
15. The thermoplastic polyurethane according to embodiment 14, characterized in that the at least one polyhydric alcohol (A41) is selected from the group consisting of 1,2-propylene glycol, 1,3-propylene glycol, glycerol, pentaerythritol, trimethylolpropane, 1,4,6-octanetriol, 1,4-butanediol, 1,5-pentanediol, 2,4-pentanediol, 1,6-hexanediol, dodecanediol, octanediol, chloropentanediol, glycerol monallyl ether, glycerol monoethyl ether, diethylene glycol, 2-ethylhexanediol-1,4, cyclohexanediol-1,4, 1,2,6-hexanetriol, 1,3,5-hexanetriol, 1,3-bis-(2-hydroxyethoxy) propane, 1,4-butylene glycol, 2,3-butylene glycol, neopentyl glycol, 1,4-bis-(hydroxymethyl)cyclohexane and trimethylolethane.
16. The thermoplastic polyurethane according to embodiment 14, characterized in that the at least one polycarboxylic acid (A42) is selected from the group consisting of phthalic acid, isophthalic acid, terephthalic acid, tetrachlorophthalic acid, maleic acid, dodecylmaleic acid, octadecenylmaleic acid, fumaric acid, aconitic acid, trimellitic acid, tricarballylic acid, 3,3′-thiodipropionic acid, succinic acid, adipic acid, malonic acid, glutaric acid, pimelic acid, sebacic acid, cyclohexane-1,2-dicarboxylic acid, 1,4-cyclohexadiene-1,2-dicarboxylic acid, 3-methyl-3,5-cyclohexadiene-1,2-dicarboxylic acid and terephthalic acid.
17. The thermoplastic polyurethane according to one or more of embodiments 2 to 16, characterized in that the at least one polyether polyol (A1) is a combination of the at least one polyether polyol (A1) and a polyether polyol (A1′) which are structurally different from each other.
18. The thermoplastic polyurethane according to embodiment 17, characterized in that the polyether polyol (A1′) has a weight average molecular weight Mw in the range of 800 g/mol to 5,000 g/mol determined using size exclusion chromatography.
19. The thermoplastic polyurethane according to embodiment 17 or 18, characterized in that the polyether polyol (A1′) has a weight average molecular weight Mw in the range of 900 g/mol to 3,000 g/mol determined using size exclusion chromatography.
20. The thermoplastic polyurethane according to one or more of embodiments 17 to 19, characterized in that the polyether polyol (A1′) is derived from monomers selected from the group consisting of ethylene oxide, propylene oxide, butylene oxide, epichlorohydrin, styrene oxide and tetrahydrofuran.
21. The thermoplastic polyurethane according to embodiment 19, characterized in that the polyether polyol (A1′) is derived from tetrahydrofuran.
22. The thermoplastic polyurethane according to one or more of embodiments 2 to 21 further comprising at least one catalyst (A5).
23. The thermoplastic polyurethane according to one or more of embodiments 1 to 22, characterized in that the at least one primary reinforcing agent (B) is selected from the group consisting of metal fiber, metalized inorganic fiber, metalized synthetic fiber, glass fiber, polyester fiber, polyamide fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.
24. The thermoplastic polyurethane according to embodiment 23, characterized in that the at least one primary reinforcing agent (B) is a glass fiber.
25. The thermoplastic polyurethane according to embodiment 22 or 23, characterized in that the glass fiber is made from chopped glass fiber and/or short glass fiber.
26. The thermoplastic polyurethane according to one or more of embodiments 1 to 26, characterized in that the at least one primary reinforcing agent (B) has an average dimension in the range of 1 μm to 20 μm determined according to ASTM D578-98.
27. The thermoplastic polyurethane according to one or more of embodiments 1 to 27, characterized in that the at least one primary reinforcing agent (B) is subjected to a surface treatment agent.
28. The thermoplastic polyurethane according to embodiment 27, characterized in that the surface treatment agent is a coupling agent selected from the group consisting of a silane coupling agent, titanium coupling agent and aluminate coupling agent.
29. The thermoplastic polyurethane according to embodiment 28, characterized in that the surface treatment agent is a silane coupling agent selected from the group consisting of aminosilane, epoxysilane, methyltrimethoxysilane, methyltriethoxysilane, γ-glycidoxypropyltrimethoxysilane, vinyltriacetoxysilane and vinyltrimethoxysilane.
30. The thermoplastic polyurethane according to embodiment 29, characterized in that the silane coupling agent is epoxysilane or aminosilane.
31. The thermoplastic polyurethane according to one or more of embodiments 1 to 30 further comprising at least one additive (D).
32. The thermoplastic polyurethane according to claim 31, characterized in that the at least one additive (D) is selected from the group consisting of wax, lubricant, ultraviolet light stabilizer, antioxidant, compatibilizer, surfactant, friction modifier, crosslinker, plasticizer, flame retardant and colorant.
33. The thermoplastic polyurethane according to one or more of embodiments 1 to 32, characterized in that the moldable reinforced thermoplastic polyurethane when molded into an non-pneumatic wheel has a creep recovery of less than 14% at 40° C. after 48 h.
34. The thermoplastic polyurethane according to one or more of embodiments 1 to 33, characterized in that the non-pneumatic wheel is obtained by injection molding or extrusion.
35. A process for preparing a moldable reinforced thermoplastic polyurethane according to one or more of embodiments 1 to 34, comprising the steps of:
   (a) blending the at least one thermoplastic polyurethane (A) with the at least one primary reinforcing agent (B) in the weight ratio between the at least one reinforcing agent (B) and the at least one thermoplastic polyurethane (A) in the range of 0.01:1.0 to 1.0:1.0, optionally in the presence of the at least one additive (D) to obtain a moldable reinforced thermoplastic polyurethane having a Shore D hardness in the range of 40 to 80 determined according to ASTM D2240,
   wherein the moldable reinforced thermoplastic polyurethane when molded into an non-pneumatic wheel has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.
36. The process according to embodiment 35, characterized in that the moldable reinforced thermoplastic polyurethane when molded into an non-pneumatic wheel has a creep recovery of less than 14% at 40° C. after 48 h.
37. A method of molding an non-pneumatic wheel comprising the steps of:
   (a′) melting a moldable reinforced thermoplastic polyurethane according to one or more of embodiments 1 to 34, and
   (b′) molding the moldable reinforced thermoplastic polyurethane of step (a′) to obtain an non-pneumatic wheel having a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.
38. The method according to embodiment 37, characterized in that in step (b′) injection molding or extrusion takes place.
39. The method according to embodiment 37 or 38, characterized in that the non-pneumatic wheel has a creep recovery of less than 14% at 40° C. after 48 h.
40. Use of the moldable reinforced thermoplastic polyurethane according to one or more of embodiments 1 to 34 or the moldable reinforced thermoplastic polyurethane obtained according to embodiment 35 or 36 for molding into a non-pneumatic wheel.
41. The use according to embodiment 40, characterized in that the molding is selected from the group consisting of injection molding or extrusion.
42. The use according to embodiment 40 or 41, characterized in that what is meant by molding into a non-pneumatic wheel is that the only the plurality of spokes of the pneumatic tire are molded according to embodiment 40 or 41.
43. An non-pneumatic wheel comprising the moldable reinforced thermoplastic polyurethane according to one or more of embodiments 1 to 34 or the moldable reinforced thermoplastic polyurethane obtained according to embodiment 35 or 36 or obtained according to one or more of embodiments 37 to 39.

### Examples

### Compounds

Polyol

| | |
|---|---|
| Polyol 1 | Polytetrahydrofuran with Mn = 1000 |
| | g/mol |
| Polyol 2 | Polytetrahydrofuran with Mn = 2000 |
| | g/mol |
| Diisocyanate | 4,4′-diphenylmethane diisocyanate |
| | (MDI) having NCO content of 33.5 wt.-% |
| Chain extender | 1,3-propanediol |
| were obtained from BASF | |
| Primary reinforcing agent | Chopped fiber glass with silane sizing |
| was obtained from PPG | and having an average fiber diameter |
| Fiber Glass | of 10 μm |

### Standard Methods

| | |
|---|---|
| 2% secant modulus | ASTM D412 |
| Shore D hardness | ASTM D2240 |
| Average dimension | ASTM D578-98 |

The weight average molecular weight, Mw, was determined using size exclusion chromatography procedure with the following parameters:

| | |
|---|---|
| Column | PLgel 5 μm Guard column, 100000 and 500 Å |
| | columns at 80° C. |
| Mobile phase | Dimethylformamide (DMF) with 0.05 wt.-% LiBr |
| Flow rate | 0.8 mL/min |
| Sample injection | 100 μL of 1 mg/mL |
| Detector | Differential refractometer at 38° C. |
| Calibration | EasiCal polystyrene standards with molecular |
| | weights of M = 10,000 Da to 70,00,000 Da |

### General Synthesis of Moldable Reinforced Thermoplastic Polyurethane

TPU resins were prepared in either batch processes or continuous processes. For batch processes, in a 2 L metal container, polyol chain extender, and additives such as waxes or heat stabilizers were mixed with a mechanical stirrer. The container was then subsequently covered and placed inside a hot air oven preheated at 85° C. The preheated mixture was taken out of the oven and, in a separate vessel, polyisocyanate was heated to a temperature of 55° C. Once the temperature of the polyol mixture reached 80° C., the preheated polyisocyanate was added and the mixture stirred at 300 rpm. When the reacting materials reached 110 C due to the exothermic reaction, the mixture was poured into a teflon frame kept over a hot plate having a temperature of 120° C. to obtain a TPU slab. Once the TPU slab turned solid, it was removed from the hot plate and subsequently annealed inside a hot oven at 100° C. for 20 h. The TPU was allowed to cool gradually, followed by being shredded to small granulates. The granulates were dried at 110° C. for 3 h.

For continuous processes, the polyols, chain extenders, additives, and isocyanates were maintained in individual tanks to preheat them. When the materials were at their required temperatures they were dosed into a vessel that mixes the ingredients such as a mixpot or a reaction extruder. The ingredients can be added individually, together, at one location, or over multiple locations to improve the reaction. The polymerization takes place either on a conveyor belt or inside a reaction extruder barrel and was then shredded into granulates or pelletized underwater. Pellets and granulates were cured and dried before use the same as the batch process.

Once the pellets or granulates were cured and dried, they were mixed with the reinforcement using a twin-screw compounder or other method familiar to those skilled in the art. They were then pelletized or granulated, cured, and dried to make them ready for molding into non-pneumatic wheels or test samples.

Table 1 below reports the amount of different components present in the moldable reinforced thermoplastic polyurethane.

TABLE 1

| | | | | | | Primary |
|---|---|---|---|---|---|---|
| | | | Di- | Chain | | reinforcing |
| | Polyol (g) | | isocyanate | extender | | agent |
| Examples | Polyol 1 | Polyol 2 | (g) | (g) | | (g) |
| Ex. 1 | 36.44 | — | 50.99 | 12.57 | — | 13.25 |
| Ex. 2 | 22.80 | 15.20 | 49.43 | 12.58 | — | 12.50 |
| Ex. 3 | 33.83 | — | 52.84 | 13.33 | — | 10.25 |
| Ex. 4 | 21.13 | 14.09 | 51.44 | 13.35 | — | 10.50 |

In order to determine the 2% secant modulus, test samples were annealed at 80° C. for 20 hours after molding, then rested at room temperature for at least 24 hours. Tensile testing and dynamic mechanical analysis were conducted on ASTM D412 Die “C” specimen stamped from 2 mm thick injection molded test plaques. Calculation of the 2% secant modulus was done by dividing the stress measured at 2% strain by 0.02. Table 2 summarizes the results obtained.

### Procedure for Obtaining the Sample for Creep Recovery and Fatigue Life

The test specimen for creep and fatigue testing was a V-shaped I-beam with round edges (see FIG. 1 and FIG. 2) with the following dimensions of the mold:

| Reference numeral | Description | Dimension |
|---|---|---|
| A | First flat horizontal surface | 0.025 m |
| B | First flat vertical surface | 0.004 m |
| C | Total vertical height of the geometry | 0.076 m |
| D | First flat inclined surface | 0.042 m |
| E | Second flat inclined surface | 0.042 m |
| F | First thickness | 0.004 m |
| G | Second thickness | 0.002 m |
| H | First rounded surface | 0.012 m |
| I | Second rounded surface | 0.002 m |
| J | Third rounded surface | 0.006 m |
| K | Fourth rounded surface | 0.009 m |
| L | Fifth rounded surface | 0.007 m |
| M | First rounded edge | 0.001 m |
| N | Second rounded edge | 0.002 m |
| O | Outer angle | 25.305° |
| P | Inner angle | 27.305° |
| Q | Second flat horizontal surface | 0.025 m |
| R | Third rounded edge | 0.001 m |

The mold dimensions, as described hereinabove, have a tolerance typically of ±0.005 inches and the test specimen obtained using the said mold contracts not more than 3%.

The fatigue resistance was measured using a dynamic servo hydraulic tensile testing station. Testing was conducted at 23° C. at a frequency of 10 Hz. One strain cycle displaces the test specimen ±10 mm from its neutral position. Excellent fatigue life was considered as achieving 10 million strain cycles under the prescribed conditions without breaking, cracking, or showing significant hazing or whitening.

The pair of test specimen were clamped at the top and bottom. The pair of test specimens were clamped back-to-back to neutralize any torque generated by the offset load and ensure that the displacement was only along the vertical axis. A constant force was applied to the bottom clamp and the top clamp was fixed in place. The force to be applied to the pair test specimen for creep testing was determined ahead of time by using a tensile testing station to measure the force required to extend the test specimen 10 mm. This force was applied to the test specimens for 48 hours, causing the test specimens to elongate. The constant force was then removed and the test specimens were then placed at 23° C. for another 24 hours, after which the height of the test specimens were recorded. The nonrecoverable deformation, or creep, was defined as the ratio of the initial geometry to the final geometry and was reported as a percentage. Excellent creep resistance was considered as less than 14% nonrecoverable deformation under the prescribed conditions. Table 2 below summarizes the results obtained.

TABLE 2

| | Fatigue life | 2% secant modulus | Creep recovery |
|---|---|---|---|
| Examples | (million cycles) | (MPa) | (%) |
| Ex. 1 | 16+ | 1014.50 | 13.50 |
| Ex. 2 | 20+ | 815.55 | 12.40 |
| Ex. 3 | 4.9+ | 942.27 | 13.30 |
| Ex. 4 | 9.5+ | 1302.83 | 13.40 |

+implies that the sample testing was stopped while the fatigue life was still increasing with no signs of failure

It was observed that the 1,3-propanediol formed a tighter hard phase network of the thermoplastic polyurethane resin. The tighter hard phase resulted in an unexpected and unique advantage in that it increased the modulus of the TPU, which subsequently allowed lower loadings of the reinforcement to be required to reach the same modulus target of the moldable reinforced thermoplastic polyurethane. Having less reinforcement further improved the fatigue resistance of the non-pneumatic wheels comprised of the moldable reinforced thermoplastic polyurethane.

1. A non-pneumatic wheel comprising an outer band, a hub, and a plurality of spokes, the plurality of spokes connecting the outer band to the hub, the outer band forming a contact patch when pressed against a surface, the outer band having a deflection in the contact patch the under normal loading conditions, the non-pneumatic wheel defining an axis of rotation and defining axial, radial, and circumferential directions,
wherein the plurality of spokes are made from a moldable reinforced thermoplastic polyurethane comprising:
(A) at least one thermoplastic polyurethane, and
(B) at least one primary reinforcing agent,
wherein the weight ratio between the at least one reinforcing agent (B) and the at least one thermoplastic polyurethane (A) is in the range of 0.01:1.0 to 1.0:1.0, and
wherein the moldable reinforced thermoplastic polyurethane when molded into a spoke has a fatigue life of at least 10 million cycles at sinusoidal strain of frequency 10 Hz at a displacement of ±10 mm per cycle at 23° C. and a 2% secant modulus at 20° C. in the range of 500 MPa to 3000 MPa determined according to ASTM D412.

2. The non-pneumatic wheel according to claim 1, characterized in that the at least one thermoplastic polyurethane (A) comprises:
(A1) at least one polyether polyol having a weight average molecular weight Mw in the range of 800 g/mol to 5,000 g/mol determined using size exclusion chromatography,
(A2) at least one diisocyanate, and
(A3) at least one low molecular weight diol having a molecular weight in the range of 60 to 400 g/mol.

3. The non-pneumatic wheel according to claim 2, characterized in that the at least one polyether polyol (A1) is derived from monomers selected from the group consisting of ethylene oxide, propylene oxide, butylene oxide, epichlorohydrin, styrene oxide and tetrahydrofuran.

4. The non-pneumatic wheel according to claim 3, characterized in that the at least one diisocyanate (A2) is selected from the group consisting of 2,4′-diphenylmethane diisocyanate, 4,4′-diphenylmethane diisocyanate, tolylene 2,6-diisocyanate, dicyclohexylmethane 2,2′-diisocyanate, dicyclohexylmethane 4,4′-diisocyanate, hexamethylene 1,6-diisocyanate, paraphenylene 2,4-diisocyanate, tetramethylenexylene 2,4-diisocyanate, 2 methylpentamethylene 1,5 diisocyanate, 2 ethylbutylene 1,4 diisocyanate, pentamethylene 1,5 diisocyanate, butylene 1,4 diisocyanate, 1 isocyanato-3,3,5 trimethyl-5 isocyanatomethylcyclohexane, 2,4′-toluene diisocyanate, 2,6′-toluene diisocyanate, and 1,5-naphthalene diisocyanate.

5. The non-pneumatic wheel according to claim 2, characterized in that the at least one low molecular weight diol (A3) is selected from the group consisting of ethylene glycol, diethylene glycol, triethylene glycol, propylene glycol, 1,3-propanediol, 1,4-butanediol, 1,5-pentanediol, 1,6-hexanediol, 1,4-butylene glycol, 1,5-pentylene glycol, methylpentanediol, 1,6-hexylene glycol, neopentyl glycol, trimethylolpropane, glycerol, pentaerythritol, diglycerol, dextrose, 1,4:3,6 dianhydrohexitol, hydroquinone bis 2-hydroxyethyl ether and bis-2(hydroxy ethyl)-terephthalate.

6. The non-pneumatic wheel according to claim 1, characterized in that the at least one thermoplastic polyurethane (A) further comprises at least one polyester polyol (A4).

7. The non-pneumatic wheel according to claim 2, characterized in that the at least one polyether polyol (A1) is a combination of the at least one first polyether polyol (A1) and a second polyether polyol (A1′) which are structurally different from each other.

8. The non-pneumatic wheel according to claim 7, characterized in that the second polyether polyol (A1′) has a weight average molecular weight Mw in the range of 800 g/mol to 5,000 g/mol determined using size exclusion chromatography.

9. The non-pneumatic wheel according to claim 1, characterized in that the at least one primary reinforcing agent (B) is selected from the group consisting of metal fiber, metalized inorganic fiber, metalized synthetic fiber, glass fiber, polyester fiber, polyamide fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.

10. The non-pneumatic wheel according to claim 1, characterized in that the at least one primary reinforcing agent (B) has an average dimension in the range of 1 μm to 20 μm determined according to ASTM D578-98.

11. The non-pneumatic wheel according to claim 1, characterized in that the at least one primary reinforcing agent (B) is subjected to a surface treatment agent.

12. The non-pneumatic wheel according to claim 11, characterized in that the surface treatment agent is a coupling agent selected from the group consisting of a silane coupling agent, titanium coupling agent and aluminate coupling agent.

13. The non-pneumatic wheel according to claim 1, characterized in that the moldable reinforced thermoplastic polyurethane when molded into the spoke has a creep recovery of less than 14% at 40° C. after 48 h.

14. The non-pneumatic wheel according to claim 1, characterized in that the spoke is obtained by injection molding or extrusion.

15. A process for preparing a moldable reinforced thermoplastic polyurethane, comprising the steps of:
(a) blending the at least one thermoplastic polyurethane (A) with the at least one primary reinforcing agent (B) in the weight ratio between the at least one reinforcing agent (B) and the at least one thermoplastic polyurethane (A) in the range of 0.01:1.0 to 1.0:1.0, optionally in the presence of the at least one additive (D) to obtain a moldable reinforced thermoplastic polyurethane having a Shore D hardness in the range of 40 to 80 determined according to ASTM D2240,
wherein the moldable reinforced thermoplastic polyurethane when molded into the spoke has a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

16. A method of molding a spoke for a non-pneumatic wheel comprising the steps of:
(a′) melting a moldable reinforced thermoplastic polyurethane according claim 1, and
(b′) molding the moldable reinforced thermoplastic polyurethane of step (a′) to obtain a spoke having a fatigue life of at least 10 million cycles at sinusoidal strain of frequency 10 Hz at a displacement of ±10 mm per cycle at 40° C. and a 2% secant modulus at 20° C. in the range of 500 MPa to 3000 MPa determined according to ASTM D412.

17. Use of the moldable reinforced thermoplastic polyurethane according to claim 15 for molding into a spoke for a non-pneumatic wheel.

18. A spoke for a non-pneumatic wheel comprising the moldable reinforced thermoplastic polyurethane obtained according to claim 15.

19. A spoke for a non-pneumatic wheel comprising the moldable reinforced thermoplastic polyurethane obtained according to claim 16.
